(19) United States
(12) Patent Application Publication
(10) Pub. No.: US 2021/0294229 A1
(43) Pub. Date: Sep. 23, 2021

(54) IMAGE FORMING APPARATUS, TONER, TWO-COMPONENT DEVELOPING AGENT, AND IMAGE FORMING METHOD

(71) Applicant: RICOH COMPANY, LTD., Tokyo (JP)

(72) Inventors: Hideki SUGIURA, Shizuoka (JP); Maiko KOEDA, Shizuoka (JP); Masahiko ISHIKAWA, Shizuoka (JP); Hiroshi SEO, Kanagawa (JP); Yuusuke FURUICHI, Kanagawa (JP); Takamasa HASE, Tokyo (JP)

(21) Appl. No.: 17/203,814

(22) Filed: Mar. 17, 2021

(30) Foreign Application Priority Data
Mar. 17, 2020 (JP) 2020-046334

(51) Int. Cl. G03G 9/087; G03G 9/08; G03G 15/20

(52) U.S. Cl. CPC G03G 9/08755; G03G 9/08711; G03G 2215/0607; G03G 9/0827; G03G 15/2064; G03G 9/0821

(57) ABSTRACT

An image forming apparatus includes a developing device accommodating toner, the toner containing:

a binder resin; and a coloring agent; and a fixing device configured to fix a toner image formed with the toner on a recording medium, the fixing device comprising: a tubular belt member; a heating member configured to heat the tubular belt member directly or indirectly in contact with the tubular belt member; and a pressing member in contact with the tubular belt member, wherein the toner under a load of 2 kg has a flow index Tf of from 70 to 121 degrees C., a flow index Te of from 83 to 120 degrees C., and a softening index Tw of from 65 to 80 degrees C.

### CROSS-REFERENCE TO RELATED APPLICATIONS

This patent application is based on and claims priority pursuant to 35 U.S.C. § 119 to Japanese Patent Application No. 2020-046334, filed on Mar. 17, 2020, in the Japan Patent Office, the entire disclosure of which is hereby incorporated by reference herein.

### BACKGROUND

### Technical Field

The present disclosure relates to an image forming apparatus, a two component developing agent, and an image forming method.

### Description of the Related Art

The present disclosure relates to an image forming apparatus, a toner, a two component developing agent, and an image forming method.

### DESCRIPTION OF THE RELATED ART

An electrophotographic or electrostatic recording apparatus forms toner images onto transfer material, typically paper, by attaching toner to latent electrostatic images formed on a photoconductor to render them visible and transferring and fixing the visible image onto the transfer material. Full color images are generally reproduced with four color toners of black, yellow, magenta, and cyan; images are formed by developing with each color toner and overlapping each toner layer followed by heating to simultaneously fix the toner layers, thereby obtaining full color images.

### SUMMARY

According to embodiments of the present disclosure, provided is an image forming apparatus which includes a developing device accommodating toner, the toner containing: a binder resin; and a coloring agent; and a fixing device configured to fix a toner image formed with the toner on a recording medium, the fixing device comprising: a tubular belt member; a heating member configured to heat the tubular belt member directly or indirectly in contact with the tubular belt member; and a pressing member in contact with the tubular belt member, wherein the toner under a load of 2 kg has a flow index Tf of from 70 to 121 degrees C., a flow index Te of from 83 to 120 degrees C., and a softening index Tw of from 65 to 80 degrees C.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of the image forming apparatus according to an embodiment of the present disclosure;

FIG. 2 is a schematic diagram illustrating an example of a fixing device;

FIG. 3 is a schematic diagram illustrating another example of a fixing device;

FIG. 4 is a schematic diagram illustrating another example of a fixing device;

FIG. 5 is a schematic diagram illustrating another example of a fixing device;

FIG. 6A is a schematic diagram illustrating a measuring instrument for measuring flow starting index Tf of toner;

FIG. 6B is a schematic diagram illustrating an example of the flow curve for obtaining the flow starting index Tf of toner;

FIG. 7 is a schematic diagram illustrating another example of the image forming apparatus according to an embodiment of the present disclosure;

FIG. 8 is a schematic diagram illustrating another example of the image forming apparatus according to an embodiment of the present disclosure.

FIG. 9 is a schematic diagram illustrating another example of the image forming apparatus according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

An image heating device is known as a fixing device having a heating member having a linear heating surface, a sheet sliding with the heating member, and a power distributor for pulse-energizing the linear hearing surface. The heating member heats images via the sheet followed by cooling; the recording substrate bearing an image is separated from the sheet. However, it involves a problem of gloss instability of a fixed image attributable to uneven fixing temperatures caused by a low surface pressure and a small heat capacity of the heating member.

It is effective to reduce the fixing energy by enhancing the fixing property by lowering the fixing temperature while increasing the fixing surface pressure. However, it readily causes coiling of a recording medium during fixing and hot offset under a high surface pressure. On the other hand, the fixing temperature along the latitudinal direction of printing readily becomes uneven in a low surface pressure fixing system; uneven fixing temperatures change the fixing property or leads to uneven gloss on the surface on the image even when an image is fixed. For this reason, toner is required to have excellent fixing heat load property.

Low softening resin is known to cause toner spent on the developing member and carrier, thereby causing an adverse impact on the development property. It is difficult to obtain an image forming apparatus ultimately striking a balance between low temperature fixability, anti-fixing rolling, hot temperature storage, and developing stability. Toner trying to strike a balance between low temperature fixability and carrier spent has been proposed; however, it involves a problem of gloss stability and it is not compatible with the low surface pressure fixing system.

According to the present disclosure, an image forming apparatus is provided which strikes a balance between the gloss stability and the low temperature fixability.

Image Forming Apparatus and Image Formation Method

The image forming apparatus of the present disclosure includes a developing device accommodating toner, a fixing device, and other optional devices.

The image forming method of the present disclosure fixes toner images with a fixing device.

The fixing device fixes a toner image formed with the toner onto a recording medium.

The fixing device includes a tubular belt member, a heating member for heating the belt member in directly or indirectly contact with the belt member, and a pressing member in contact with the belt member.

The toner includes a binder resin, a coloring agent, and other optional components.

The toner under a load of 2 kg has a flow index Tf of from 70 to 121 degrees C., a flow index Te of from 83 to 120 degrees C., and a softening index Tw of from 65 to 80 degrees C.

Low surface pressure fixing systems represented by using a fixing device having a planar heating member for heating a belt member are excellent to reduce the size and save the energy and the cost.

Unlike a tubular heating member, such a planar heating member can heat a belt member with only one side of the heating member; the heating member device cannot heat the portion of the belt member not in contact with the side. The fixing temperature of a low surface pressure fixing system is not uniform along the rotation direction of a belt member (circumference direction of a tubular belt member).

This uneven fixing temperature of the belt member in a low surface pressure fixing system degrades the gloss stability of images.

The present inventors have made an image forming apparatus demonstrating excellent gloss stability and excellent low temperature fixability by reviewing characteristics of toner.

The image forming apparatus includes a low surface pressure fixing system having a fixing device for heating a belt member with a heating member and a developing device accommodating toner satisfying the following conditions at the same time to strike a balance between the gloss stability and low temperature fixability.

(1) Flow index Tf of toner under a load of 2 kg is from 70 to 121 degrees C.
(2) Flow index Te of toner under a load of 2 kg is from 83 to 120 degrees C.
(3) Softening index Tw of toner under a load of 2 kg is from 65 to 80 degrees C.

The reason why the image forming apparatus can demonstrate such properties is not clear; however, the following is inferred on a basis of the analysis results.

It is appropriate to control the melting property of toner at a low surface pressure (small load) for fixing via a belt member; the melting property of toner under a small load of 2 kg is regulated and controlled.

The flow index Tf corresponds to the flow starting temperature of the toner when the load of a flow tester is set to be 2 kg. The melting property of a low temperature fixing toner is suitable in the range of the flow index Tf of from 70 to 121 degrees C. When the flow index Tf is lower than 70 degrees C., the melting property is good at low temperatures; however, it involves a problem of gloss stability. When toner is excessively melted, the viscosity of the toner deteriorates, which readily changes the state at the melted portion and non-melted portion. A slight change in the fixing temperature occurring to toner leads to a significant change in the molten state. The gloss stability deteriorates in such a molten state. It is not preferable that the flow index Tf be greater than 121 degrees C. because the low temperature fixability becomes insufficient.

A flow index Te of toner of from 83 to 120 degrees C. lowers gloss dependency on the fixing temperature of the toner; gloss stability is enhanced. The flow index Te is defined by the difference between the flow ending index (Tend) and the softening index Tw in flow tester measuring as Te=Tend −Tw. The flow index Te represents the temperature from when the toner starts melting until when the toner flows out. Small values mean high sharp melting property. When the flow index Te is lower than 83 degrees C., the sharp melting property is excessively high, meaning excessive dependency of toner gloss on temperature so that obtained fixing images involve uneven gloss (or uneven density owing to uneven gloss because of slightly uneven fixing temperatures of a fixing unit, caused by paper type, image pattern (paper gap between white paper), printing speed, external factors (air conditioning, place of installation), which is not preferable. Conversely, when the flow index Te surpasses 121 degrees C., gloss dependency of toner lowers (i.e., gloss stability is enhanced); however, the melting property deteriorates, which causes cold offset and is not preferable.

“Sharp melt” means compatible in a short period of time.

A softening index Tw of toner of from 65 to 80 degrees C. improves developing reliability of toner and image forming system in an environment such as a room temperature environment, high temperature and high humidity environment, or low temperature and low humidity environment. The softening index Tw contributes to softening property, gloss stability, and low temperature fixability. When the softening index Tw is lower than 65 degrees C., the molten state of toner readily changes because the toner becomes excessively softened, which degrades the gloss stability. This degradation is not preferable. Conversely, when the softening index Tw surpasses 80 degrees C., the toner is not readily softened; the low temperature fixability of toner deteriorates. This deterioration is not preferable.

The flow index Tf is preferably from 70 to 98 degrees C. and more preferably from 80 to 95 degrees C. because the melting property becomes suitable for a lower temperature fixing toner in the ranges.

The flow index Te is preferably from 89 to 110 degrees C. to minimize the gloss dependency on the fixing temperature of toner.

The softening index Tw is preferably from 67 to 75 degrees C. because the developing reliability of toner and image forming system is enhanced in an environment such as a room temperature environment, high temperature and high humidity environment, or low temperature and low humidity environment.

The binder resin preferably contains crystalline polyester resin. A binder resin containing a crystalline polyester resin enhances low temperature fixability owing to the sharp melt property of the crystalline polyester resin and the plasticization effect of the crystalline polyester resin to other binder resins.

The binder resin preferably contains a non-crystalline polyester resin. When the binder resin contains a non-crystalline polyester resin, the thermal property and viscoelasticity of toner are readily controlled. For this reason, gloss dependency on the fixing temperature of toner further lowers.

It is preferable that the binder resin contain a crystalline polyester resin and the on-crystalline polyester resin contain a modified polyester resin. Viscoelasticity controllability attributable to mutual action of the modified polyester resin and the crystalline polyester resin is enhanced, thereby reducing variation of toner gloss property.

The toner preferably has a core-shell structure. The gloss dependency on the fixing temperature of toner further lowers because of the core-shell structure of the toner. The shell layer may partially or entirely covers the surface of a core. The shell layer may be present on the surface of a core in an island shape.

It is preferable that the weight average particle diameter (D4) of the toner be from 2.0 to 6.0 μm and the ratio (D4/Dn) of D4 to the number average particle diameter (Dn) be from 1.00 to 1.20. The toner has a uniform particle size distribution in these ranges; the toner demonstrates finer concavo-convex followability to the roughness of each printing media (typically paper). For this reason, the fixing state of toner in the printing surface becomes uniform and lowers the variation of gloss.

The tinting strength of the toner is preferably from 1.8 to 2.2. The variation of the tinting strength to the variation of gloss can be reduced in this range. The tinting strength is defined as that of toner attaching to a medium at 0.4 mg/cm².

The average circularity of the toner is preferably from 0.93 to 0.99 and more preferably from 0.95 to 0.98. The variation of fixing on a medium during fixing lowers in these ranges.

The shape factor SF-1 of the toner is preferably from 100 to 150 and the shape factor SF-2 of the toner is preferably from 100 to 140. The variation of the fixing state (attachment to medium) during fixing caused by properties such as transfer and cleaning property) of the toner shape lowers in these ranges. Since the toner can be uniformly fixed along the surface direction, the variation of gloss can be decreased: that is, gloss stability is enhanced, which is more preferable.

It is preferable to granulate the toner by dispersing and/or emulsifying an oil phase and/or a monomer phase containing at least a toner composition and/or a precursor thereof in an aqueous medium. Such toner enhances uniformity between toner particles and the inside of particles so that the variation of the fixing state (attachment on medium) during fixing further lowers and furthermore the variation of the gloss of toner is furthers minimized.

The toner preferably achieves cross-linking and/or elongation reaction of a toner composition containing a polymer having a portion reactive with a compound having an active hydrogen group, a polyester resin, a coloring agent, and a releasing agent in an aqueous medium under the presence of fine resin particles. Such toner enhances uniformity between toner particles and the inside of particles so that the variation of the fixing state (attachment on medium) during fixing further lowers and furthermore the variation of the gloss of toner is furthers minimized.

The pressurizing surface pressure during fixing by the fixing device mentioned above is preferably from 0.5 to 5 N/cm². The toner can be fixed onto a recording medium at a suitable surface pressure in this range so that the variation of the fixing state (attachment on medium) during fixing further lowers and furthermore the variation of the gloss of toner further lowers.

The belt member preferably has a substrate layer, a surface layer, and an elastic layer disposed between the substrate layer and the surface layer. The toner can be fixed onto a recording medium at a suitable surface pressure and attachability in this configuration so that the variation of the fixing state (attachment on medium) during fixing further lowers and furthermore the variation of the gloss of toner further lowers.

The elastic layer preferably has an average thickness of from 50 to 500 μm. The toner can be fixed onto a recording medium at a suitable surface pressure and attachability in this range so that the variation of the fixing state (attachment on medium) during fixing further lowers and furthermore the variation of the gloss of toner further lowers.

The image forming apparatus mentioned above includes at least four developing unit containing different developing colors arranged in tandem and preferably has a system speed of 50 to 2,500 mm/s. In such a configuration and range, the variation of the fixing state (attachment on medium) during fixing further lowers and furthermore the variation of the gloss of toner further lowers by using a toner having appropriately designed melt-gloss profile even for a fixing system that cannot secure a sufficient fixing nipping time because the system linear speed is too high.

The image forming apparatus preferably employs a two-component development system using a two-component developing agent containing the toner and magnetic carrier. Such an apparatus makes it possible to more stably function the image forming system so that the uniformity of the amount of toner attached during fixing is enhanced, thereby preventing the fixing state (attachment on medium) during fixing from varying.

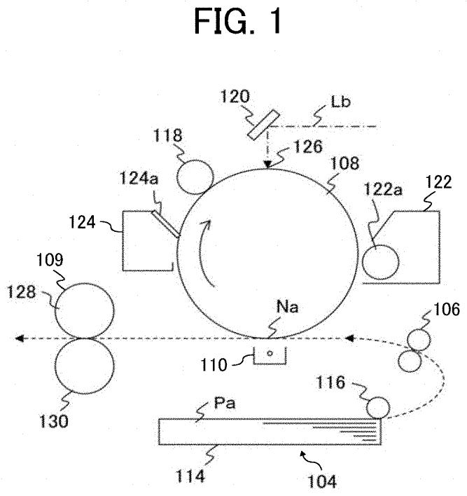

FIG. 1 is a schematic diagram illustrating a cross section of an example of an image forming apparatus.

As illustrated in FIG. 1, the printer as an example of the image forming apparatus relating to the present embodiment includes at least a feeding device 104, a pair of registration rollers 106, a drum photoconductor 108 as an image bearer, a transfer device 110, and a fixing device 109.

The feeding device 104 includes at least a sheet feeding tray 114 in which sheets Pa as recording substrates, typically paper, are stacked and sheet feeding rollers 116 for feeding the paper Pa stacked in the sheet feeding tray 114 from the top of the stack while separating the paper Pa one piece by one piece.

The paper Pa fed by the sheet feeding rollers 116 is temporarily stopped by the registration rollers 106, where the posture of the paper Pa is corrected. The registration rollers 106 feed the paper Pa to a transfer site Na in synchronization with the rotation of the drum photoconductor 108, that is, in timing when the front end of the toner image formed on the drum photoconductor 108 matches the predetermined position of the front end of the paper Pa along the conveyance direction.

Around the drum photoconductor 108, there are provided a charging roller 118 as a charging device, a mirror 120 partially constituting an irradiator, a developing device 122 equipped with a developing roller 122a containing toner and optionally carrier, a transfer device 110, and a cleaning device 124 equipped with a cleaning blade 124a in this order along the rotation direction of the drum photoconductor 108 indicated by the arrow.

An exposure site 126 on the drum photoconductor 108 between the charging roller 118 and the developing device 122 is exposed to and scanned by an exposure light Lb via a mirror 120.

Image forming operations by the printer are the same as typical operations.

When the drum photoconductor 108 starts rotating, the surface of the drum photoconductor 108 is uniformly charged by the charging roller 118 and exposed to and scanned by the exposure light Lb in response to image information to form a latent electrostatic image corresponding to the image that should be formed.

This latent electrostatic image moves to the developing device 122 in accordance with the rotation of the drum photoconductor 108 and is rendered visible with toner supplied to form a toner image.

The toner image formed on the drum photoconductor 108 is transferred onto the paper Pa entering into the transfer site Na at a predetermined timing upon application of a transfer bias by the transfer device 110.

The paper Pa bearing the toner image is transferred to the fixing device 109 including a fixing roller 128 and a pressing roller 130, where the toner image is fixed and then ejected to and stacked in an ejection tray.

Residual toner remaining on the drum photoconductor 108 that has not been transferred at the transfer site Na reaches the cleaning device 124 in accordance with the rotation of the drum photoconductor 108 and is scraped off by the cleaning blade 124a while the residual toner is passing through the cleaning device 124.

Thereafter, the residual potential on the drum photoconductor 108 is quenched by a quencher to make the image forming apparatus ready for the next image forming operation.

After the toner image is transferred to the paper Pa, the paper Pa is transferred to the fixing device 109, where the toner image is fixed on the paper Pa. The paper Pa is then ejected outside the device by an ejecting device to complete the series of printing operations.

The configuration of the fixing device is described next.

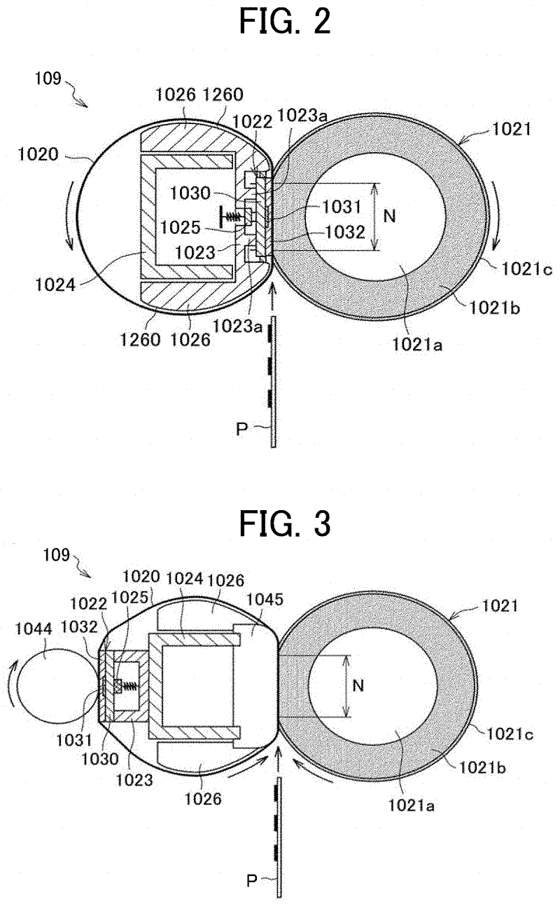

As illustrated in FIG. 2, the fixing device 109 relating to the present embodiment includes a fixing belt 1020 formed of an endless belt, a pressing roller 1021 as a facing member for forming an nipping portion N in contact with the peripheral surface of the fixing belt 1020, a heater 1022 as a heating device for heating the fixing belt 1020, a heater holder 1023 as a holding member for holding the heater 1022, a stay 1024 as a supporting member supporting the heater 1022, and a thermistor 1025 as a temperature detecting device for detecting the temperature of the fixing belt 1020.

The fixing belt 1020 has a tubular substrate made of polyimide (PI) having an outer diameter of 25 mm and a thickness of from 40 to 120 μm. The outermost surface of the fixing belt 1020 has a releasing layer with a thickness of from 5 to 50 μm made of fluororesin such as PFA and PTFE to enhance the durability and secure the releasing property. It is suitable to form an elastic layer made of a substance such as rubber with a thickness of from 50 to 500 μm between the substrate and the releasing layer (surface layer). The substrate of the fixing belt 1020 is not limited to polyimide. It can be made of heat resistant resin such as PEEK or metal such as nickel (Ni) and stainless steel (SUS). It is possible to form a slidable layer on the inner surface of the fixing belt 1020 by coating with polyimide and PTFE.

For example, the pressing roller 1021 has an outer diameter of 25 mm, a cored bar 1021a, an elastic layer 1021b formed on the surface of the cored bar 1021a, and a releasing layer 1021c formed outside the elastic layer 1021b. The elastic layer 1021b is made of silicone rubber with a thickness of, for example, 3.5 mm. It is preferable to form the releasing layer 1021c made of a fluroresin having a thickness of, for example, about 40 μm on the elastic layer 1021b to enhance the releasing property.

A biasing member biases the pressing roller 1021 to the fixing belt 1020 so that the pressing roller 1021 is pressed against the heater 1022 via the fixing belt 1020. The nipping portion N is thus formed between the fixing belt 1020 and the pressing roller 1021. The pressing roller 1021 is configured to rotate driven by a driving member; the fixing belt 1020 is rotationally driven as the pressing roller 1021 rotates in the direction indicated by the arrow in FIG. 2.

The heater 1022 is a planar heating member disposed along the longitudinal direction across the width direction of the fixing belt 1020 and includes a plate substrate 1030, a heat element 1031, and a insulating layer 1032 for covering the heat element 1031. The heater 1022 is in contact with the inner surface of the fixing belt 1020 on the side of the insulating layer 1032. The heat emitted from the heat element 1031 is transferred to the fixing belt 1020 via the insulating layer 1032. In this embodiment, the heat element 1031 and the insulating layer 132 are disposed on the substrate 1030 on the side of the fixing belt 1020 (the side of nipping portion N); it is also suitable to dispose them on the substrate 1030 and the insulating layer 132 on the side of the heater holder 1023. In such a case, since the heat of the heat element 1031 is transferred to the fixing belt 1020 via the substrate 1030, it is preferable that the substrate 1030 be made of a material having a high heat conductivity such as aluminum nitride. Since the substrate 1030 is constituted of such a material having a good heat conductivity, it is possible to sufficiently heat the fixing belt 1020 even when the heat element 1031 is disposed on the fixing belt 1020 on the opposite side to the fixing belt 1020.

The heater holder 1023 and the stay 1024 are disposed on the inner surface of the fixing belt 1020. The stay 1024 is constituted of metal channel materials and both of the ends are supported by the both of side plates of the fixing device 109. Since the stay 1024 supports the heater holder 1023 and the heater 1022 held by the heater holder 1023, the heater 1022 securely receives the pressure from the pressing roller 1021, thereby stably forming the nipping portion N while the pressing roller 1021 is under pressure by the fixing belt 1020.

The heater holder 1023 is preferably made of heat resistant materials because it is readily heated to high temperatures by the heat from the heater 1022. For example, if the heater holder 1023 is made of heat resistant resin with little heat conductivity such as LCP, it is possible to efficiently heat the fixing belt 1020 because the heat transfer from the heater 1022 to the heater holder 1023 is minimized. The heater holder 1023 is in contact with the substrate 1030 of the heater 1022 via a projection 1023a to decrease the contact area between the heater 1022 and the heater holder 1023 so that the amount of heat transferred from the heater 1022 to the heater holder 1023 can be minimized. Like the present embodiment, when the projection 1023a of the heater holder 1023 is brought into contact with the portion other than the rear side of the site where the heat element 1031 of the substrate 1030 is disposed, by which portions readily heated to high temperatures are avoided, the amount of heat transferred to the heater holder 1023 is minimized; the fixing belt 1020 is efficiently heated.

The heater holder 1023 includes a guiding portion 1026 for guiding the fixing belt 1020. The guiding portion 1026 is each provided upstream (below the heater 1022 in FIG. 2) and downstream (above the heater 1022 in FIG. 2) of the heater 1022 in the rotation direction.

At the start of printing, the pressing roller 1021 is rotationally driven in the fixing device 109 and the fixing belt 1020 is rotationally driven. Then, the inner surface of the fixing belt 1020 is brought into contact with a belt facing surface 1260 of the guiding portion 1026 and guided; the fixing belt 1020 stably and smoothly rotates accordingly. The power is supplied to the heat element 1031 of the heater 1022 so that the fixing belt 1020 is heated. At the point when the temperature of the fixing belt 1020 reaches a predetermined target temperature (fixing temperature), the paper P bearing the unfixed toner image is conveyed to the place (the nipping portion N) between the fixing belt 1020 and the pressing roller 1021, where the unfixed toner image is heated and pressed, and then fixed.

The fixing device may have configurations as illustrated in FIGS. 3 to 5 other than the fixing device illustrated in FIG. 2. The configuration of each fixing device illustrated in FIGS. 3 to 5 is briefly described below.

A pressing roller 1044 is disposed on the fixing belt 1020 in the fixing device 109 illustrated in FIG. 3 on the opposite side of the pressing roller 1021. The fixing belt 1020 is configured to be heated by the pressing roller 1044 and the heater 1022 nipped therebetween. A nipping forming member 1045 is disposed on the inner surface of the fixing belt 1020 on the side of the pressing roller 1021. The nipping member 1045 is supported by the stay 1024 and forms the nipping portion N together with the pressing roller 1021 while nipping the fixing belt 1020 The nipping member 1045 includes a guiding portion 1026 for guiding the fixing belt 1020.

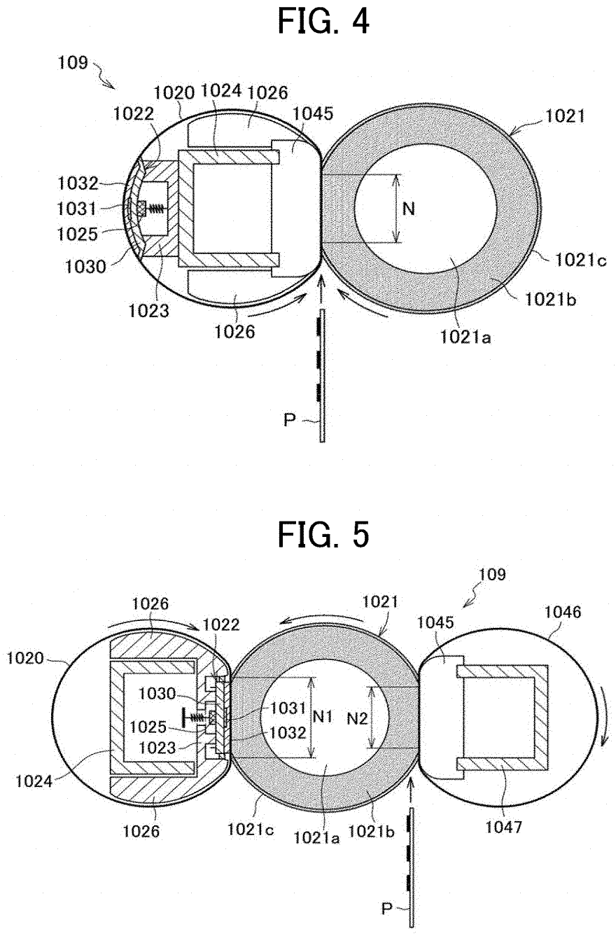

In the fixing device 109 illustrated in FIG. 4, the heater 1022 is formed in an arc shape following the curvature of the fixing belt 1020 to secure the contact length along the circumference between the fixing belt 1020 and the heater 1022 without the pressing roller 1044 mentioned above. Other portions are the same as the fixing device 109 illustrated in FIG. 3.

The fixing device 109 illustrated in FIG. 5 includes a pressing belt 1046 in addition to the fixing belt 1020 and is configured to have a heating nip (first nip portion) and a fixing nip (second nip portion). The nipping member 1045 and the stay 1047 are disposed on the pressing roller 1021 on the opposite side of the fixing belt 1020. A pressing belt 1046 is rotationally disposed enclosing the nipping forming member 1045 and the stay 1047. The paper P passes through the fixing nipping N2 between the pressing belt 1046 and the pressing roller 1021. Other portions are the same as the fixing device 9 illustrated in FIG. 2.

Toner

The toner for use in an image forming apparatus is described below.

The toner includes a binder resin, a coloring agent, and other optional components.

The toner under a load of 2 kg has a flow index Tf of from 70 to 121 degrees C., a flow index Te of from 83 to 120 degrees C., and a softening index Tw of from 65 to 80 degrees C.

Method of Evaluating Toner

Flow Index Tf, Flow Index Te, and Softening Index Tw of Toner under Load of 2 kg

The flow index Tf, flow index Te, and softening index Tw of toner under a load of 2 kg are evaluated in the following manner.

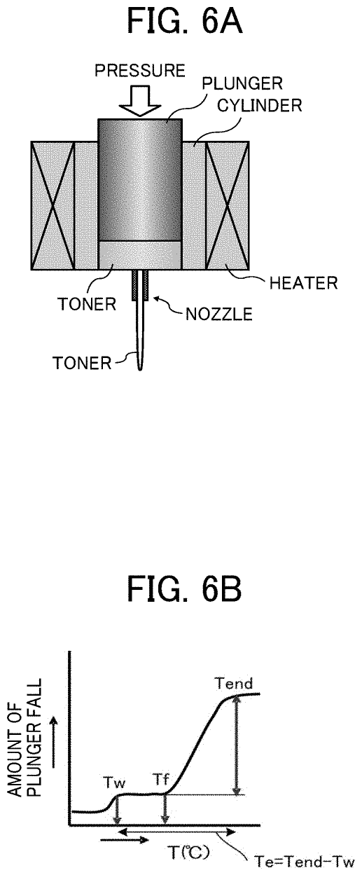

A flow tester (CFT-500D, manufactured by Shimadzu Corporation is used for evaluation. The amount of plunger falling is measured when pill-form toner melted by the heat as the temperature of the toner rises under load is flown out of the die hole (nozzle) of a device to evaluate viscoelasticity (temperature dependency) of the toner (FIG. 6A). The temperatures at which the amount of falling significantly changes are defined as the flow starting index Tf and the flow ending index Tend. The flow index Te is defined by the difference between the flow ending index (Tend) and the softening index Tw as Te=Tend−Tw. The softening index Tw is defined as the temperature at which the toner starts softening without toner flowing,

Normally, the flow tester values under a load of as relatively large as from about 10 to about 30 kg are used; however, the load is 2 kg in the present embodiment to control the toner properties corresponding to a fixing system employing a low surface pressure. Since the flow tester (CFT-500D) has a dead load of the plunger and others, measuring without a weight corresponds to a load of 2 kg.

Flow testers evaluate heat flow kinesis about flowable materials such as thermoplastic resins including flow properties for heat on a basis of the relationship between temperature, pressure, and flow speed. The heat behavior property of a material can be obtained by obtaining the flow property of the material against heat and pressure.

Flow testers are generally used under a relatively large pressure, for example, from 10 to 30 kg. However, the toner of the present disclosure is designed using the flow property on heat and pressure under a weak pressure (2 kg) as indice, which cannot be explained at such a large pressure. Therefore, the indice are separately defined on purpose to distinguish them from conventional terms such as softening temperature and are not the same as those obtained under a load of from 10 to 30 kg. Tw, Tf, Tend, and Te represent indice in temperature (degrees C.).

These indice are described with reference to FIG. 6B.

Stage 1: From Start of Heating to Tw

Toner of a thermoplastic resin having a pill-like form is solid at room temperature and not transformed by heat or pressure until a certain amount of heat or pressure is applied. The plunger distance is constant and maintains a flat straight line during this stage.

Stage 2: From Tw to Tf

The softening index Tw represents the temperature of the changing point at which the amount of plunger falling becomes constant for the first time in the heat behavior graph illustrated in FIG. 6 plotted using a flow tester under a load of 2 kg. When a sample of close-packed pilled toner obtained by pressing powdered toner is heated under a pressure and softened, the softened toner is transformed and fills the space among the pilled toner at a certain temperature (at which softened toner particles can be transformed). The volume of the entire of the pills decreases in this behavior and the plunger falls due to this volume decrease; the graph changes upward. This shrinkage continues until the space completely disappears and thereafter no change continues. This is what happens between Tw and Tf. Although a small die opening is in contact with the pill, the solid powdered toner softable to a degree that the toner can fill the space among the close packed structure cannot pass through the opening.

Stage 3: From Tf to Tend

When the toner continues to be heated under a pressure, even solid toner transfers to molten liquid with high viscosity to the degree that it can flow out of the small opening. This is the temperature indicating the flow starting index Tf. While the molten toner flows out little by little through the die opening, the amount of the plunger lowering increases and the graph transitions upward as the volume of the molten pilled toner gradually decreases. When all of the toner completely flows out, the plunger does not lower any more without a change. The temperature at which the toner completely flows out is the flow ending index Tend.

1. Sample

One gram of toner is molded under a pressure into a pill having cylindrical form with a diameter of 1 cm.

2. Temperature Condition

Temperature rising rate of 3 degrees C./min starting at 40 degrees C. until the flow ending temperature

3. Die opening diameter: 0.5 mm

4. Die length: 1.0 mm

5. Residual heating time: 200 s

Evaluation on Toner Shell Layer

The toner shell layer is evaluated in the following manner.

Evaluation Using Transmission Electron Microscope (TEM)

A spaturalful of toner is cured by embedding in an epoxy resin. A sample of the toner is exposed to ruthenium tetroxide gas or osmium tetroxide gas for five minutes to dye the shell layer and the core inside for discrimination. A cross-section of the toner is exposed with a knife to obtain an ultrathin piece (having a thickness of 200 nm) of the toner using an ultramicrotome (ULTRACUT UCT, using a diamond knife, available from Leica Corporation). Subsequently, the ultrathin piece is observed with a TEM (H7000, available from Hitachi High-Technologies Corporation) at an accelerating voltage of 100 kV.

Average Circularity E

The average circularity E of toner is defined as follows: Average circularity E=(perimeter of circle having same area as that of projection image of particle)/(perimeter of projection image of particle)×100 percent. The average circularity was measured and calculated using a flow type particle image analyzer (FPIA-2100, manufactured by Sysmex Corporation) and analyzed utilizing an analysis software (FPIA-2100 Data Processing Program for FPIA version 00-10). To be specific, 0.1 to 0.5 ml of a surfactant (alkylbenzene sulfonate, NEOGEN SC-A, manufactured by Daiichi Kogyo Co., Ltd.) at 10 percent by mass was placed in a glass beaker (100 ml). Each toner of from 0.1 to 0.5 g is added in the beaker and stirred by a microspatula. Deionized water at 80 ml is added to the mixture. The thus-obtained liquid dispersion is subjected to dispersion treatment for three minutes utilizing an ultrasonic wave dispersion device (manufactured by Honda Electronics). The toner shape and distribution are measured until the concentration of the liquid dispersion becomes 5,000 to 15,000 particles/μl using FPIA-2100. In this measuring method, it is suitable to make the concentration of the liquid dispersion from 5,000 particles/μl to 15,000 particles/μl to achieve the measuring reproducibility of the average circularity. To obtain the concentration of the liquid dispersion mentioned above, it is required to change the condition of the liquid dispersion, that is, the amount of the surfactant to be added and the amount of toner. The required amount of the surfactant varies depending on the hydrophobicity of the toner as in the measuring of the toner particle diameter. If an excessively large amount is added, the noise tends to occur due to bubbles. If an excessively small amount is added, the toner tends to be insufficiently wet, resulting in insufficient dispersion. The amount of the toner added depends on the particle diameter. In a case of a small particle diameter, the amount tends to be small and, a large particle diameter, large. When the toner particle diameter is from 3 to 7 μm, the amount of the toner added is from 0.1 to 0.5 g, thereby adjusting the concentration of the liquid dispersion to be 5,000 to 15,000 particles/μl.

Average Circularity SF-1 and SF-2

The shape factors SF-1 and SF-2 indicating circularity are defined as follows: 300 of randomly selected FE-SEM toner images obtained by measuring using a Field-Emission Scanning Electron Microscope (FE-SEM) (S-4200, manufactured by Hitachi Ltd.) are subjected to sampling and the image information is introduced into an image analyzer (Luzex AP, manufactured by NIRECO CORPORATION) via an interface. The values obtained by the following relationships 1 and 2 are defined as the shape factors SF-1 and SF-2. It is preferable to obtain the values of SF-1 and SF-2 with Luzex; however, the devices are not limited to the FE-SEM device and the image analyzer mentioned above as long as the same analysis results are obtained.

SF-1=(L2/A)×(π/4)×100

SF-2=(P2/A)×(1/4π)×100

L represents the absolute maximum length of toner, A represents the projection area of toner, and P represents the maximum perimeter of toner.

True circle is 100 for both factors. As the value increases from 100, the shape changes from circle to an irregular shape. SF-1 represents the entire shape (e.g., ellipse and sphere) of toner, and SF-2 represents the levels of roughness (concave-convex) of the surface.

Weight Average Particle Diameter, D4/Dn (Weight Average Particle Diameter/Number Average Particle Diameter)

The weight average particle diameter (D4) of toner, the number average particle diameter (Dn), and the ratio (D4/Dn) can be measured in the following manner. The average particle diameter and the particle size distribution of toner can be measured using an instrument such as Coulter Counter TA-II and Coulter Multisizer II (both manufactured by Beckman Coulter, Inc.). Coulter Multisizer II is used. The measuring method is as follows:

First, 0.1 to 5 ml of a surfactant (preferably polyoxy ethylene alkyl ether (nonionic surfactant) is added as a dispersant to 100 to 150 ml of an electrolytic aqueous solution. The electrolytic aqueous solution is NaCl aqueous solution at approximately 1 percent prepared by using primary NaCl. For example, ISOTON-II (manufactured by Beckman Coulter, Inc.) can be used. Then, 2 to 20 mg of a measuring sample is added. The electrolytic aqueous solution in which the sample is suspended is subjected to dispersion treatment with an ultrasonic wave dispersing device for about one to about three minutes and the volume and the number of toner particles or toner are measured with the measuring device mentioned above with an aperture of 100 μm to calculate the volume distribution and the number distribution. The weight average particle diameter (D4) and the number average particle diameter (D1) of the toner can be obtained from the obtained distributions.

The whole range is a particle diameter of from 2.00 to not greater than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

Tinting Strength

The tinting strength of the toner is preferably from 1.8 to 2.2. More preferably, it is from 1.9 to 2.2. The tinting strength is defined as the image density of a fixed image measured with X-Rite 938, which is obtained by fixing a latent electrostatic image at an amount of toner attached thereon of 0.4 mg/cm² with a sole fixing device (remodeled on a basis of RICOH imagio MP C5002) at a linear speed of 200 mm/s and a fixing temperature of 150 degrees C. The paper used is POD Gloss Coat (100 g/m²) manufactured by OJI PAPER CO., LTD.

System Linear Speed

The system linear speed is measured in the following manner. The system speed B is obtained using the image forming apparatus by the following relationship in the conditions of: paper size A4; printing direction in longitudinal direction (297 mm along the longitudinal direction; a run length of 100 sheets; and output time of from the start to the end: A seconds.

B(mm/sec)=100 sheets×297 mm/A sec.

Fixing Pressing Surface Pressure

The fixing pressing surface pressure can be evaluated using a general-purpose pressure sensor.

The fixing pressing surface pressure is preferably from 0.5 to 5 N/cm², more preferably from 0.5 to 2 N/cm², and furthermore preferably from 1 to 2 N/cm² because the variation of the gloss in an image surface can be minimized by a combination with the melting property of toner in a small fixing device having a good thermal efficiency.

The toner contains a binder resin, a coloring agent, and other optional components.

Binder Resin

The binder resin is not particularly limited and can be suitably selected to suit to a particular application. It includes a crystalline resin and an amorphous resin.

Crystalline Resin

Crystalline materials are defined to have atoms and molecules spaciously arranged in a repeated manner and show a diffraction pattern by a general-purpose X-ray diffraction device.

The crystalline resin is not particularly limited and can be suitably selected to suit to a particular application as long at it has crystallinity. Examples include, but are not limited to, polyester resin (crystalline polyester resin), polyurethane resin, polyurea resin, polyamide resin, polyether resin, vinyl resin, and modified crystalline resin. These can be used alone or in combination. Of these, polyester resin, polyurethane resin, polyurea resin, polyamide resin, and polyether resin are preferable. Resins having a urethane backbone and urea backbone are preferable. Linear polyester resins and complex resins containing the linear polyester resins are more preferable.

Examples of the resins having a urethane backbone and urea backbone include, but are not limited to, those mentioned above such as the polyurethane resin, polyurea resin, urethane modified polyester resin, and urea-modified polyester resin. The urethane modified polyester resin can be obtained by reacting isocyanate group-terminated polyester resin with a polyol. It is possible to obtain the urea-modified polyester resin by reacting isocyanate group-terminated polyester resin with an amine compound.

The maximum peak temperature of the heat of fusion of the crystalline resin is not particularly limited and can be suitably selected to suit to a particular application. It is preferably from 45 to 70 degrees C., more preferably from 53 to 65 degrees C., and particularly preferably from 58 to 62 degrees C. to strike a balance between the low temperature fixability and the high temperature storage.

The proportion of the crystalline resin in toner is not particularly limited and can be suitably selected to suit to a particular application. It is preferably 1 percent by mass or more, preferably 5 percent by mass or more, and particularly preferably 10 percent by mass or more to the binder resin mentioned above.

The upper limit of the proportion of the crystalline resin in the toner is not particularly limited and can be suitably selected to suit to a particular application. It can be 30 percent by mass or less to the binder resin.

Crystalline Polyester Resin

The toner preferably contains the crystalline polyester resin in an amount of 1 percent by mass or more, preferably 5 percent by mass or more, and furthermore preferably 10 percent by mass or more. The upper limit of the proportion of the crystalline polyester resin in the toner is not particularly limited and can be suitably selected to suit to a particular application. It can be 30 percent by mass or less to the toner.

The melting point of the crystalline polyester resin is preferably from 45 to 70 degrees C., more preferably from 53 to 65 degrees C., and furthermore preferably from 58 to 62 degrees C. The melting point of the crystalline polyester resin can be obtained as the peak temperature of the endothermic peak obtained by differential scanning calorimetry (DSC) in the following manner.

The rate of temperature rising is 10 degrees C./min in DSC using a differential scanning calorimeter (DSC-60 type, manufactured by Shimadzu Corporation) equipped with an automatic tangent processing system. The endothermic peak obtained is defined as the melting point.

The crystalline polyester resin represents a polymer (including copolymer) formed by copolymerization of a component constituting a polyester and other components as well as a polymer structured by a polyester alone. The polymer formed by copolymerization of a component constituting a polyester and other components has the other components in an amount of 50 percent by mass or less.

Crystalline polyester resin is synthesized by, for example, polycarboxylic acid component and polyalcohol component. The crystalline polyester resin can be procured or synthesized.

The polycarboxylic acid components include, but are not limited to, dicarboxylic acid components and tri-or higher carboxylic acid components.

Specific examples of the dicarboxylic acids include, but are not limited to, aliphatic dicarboxylic acids such as oxalic acid, succinic acid, glutaric acid, adipic acid, acid, pimelic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid; aromatic dicarboxylic acids of dibasic acids such as phthalic acid, isophthalic acid, terephthalic acid, naphthalene-2,6-dicarboxylic acid, manoic acid, and mesaconic acid; and anhydrides or lower alkylesters thereof.

Specific examples of the tri-or higher carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters. These can be used alone or in combination.

In addition to the above-specified aliphatic dicarboxylic acids and the aromatic dicarboxylic acids, diacarboxylic acid components having sulfonate group can be suitably included as the acid component. In addition to the above-specified aliphatic dicarboxylic acids and the aromatic dicarboxylic acids, diacarboxylic acid components having carbon-carbon double bond can be suitably included.

The polyhydric alcohol is not particular limited and can be suitably selected to suit to a particular application. Examples include, but are not limited to, diol and tri- or higher alcohols.

The diol is not particularly limited and can be suitably selected to suit to a particular application. Aliphatic diol is preferable and linear aliphatic diol having 7 to 20 carbon atoms in the main chain is more preferable. The number of the carbon atoms in the main chain is preferably 14 or less.

Specific examples of the aliphatic diol for use in synthesis of the crystalline polyester resin include, but are not limited to, ethylene glycol, 1,3-propane diol, 1,4-butane diol, 1,5-pentane diol, 1,6-hexane diol, 1,7 heptane diol, 1,8-octane diol, 1,9-nonane diol, 1,10-decane diol, 1,11-undecane diol, 1,12-dodecane diol, 1,13-tridecane diol, 1,14-tetradecane diol, 1,18-octadecane diol, and 1,20-eicosane diol. Of these, in terms of availability, 1,8-octane diol, 1,9-nonane diol, and 1,10-decane diol are particularly preferable.

Specific examples of the alcohols having three or more hydroxyl groups include, but are not limited to, glycerin, trimethylol ethane, trimethylol propane, and pentaerythritol.

These can be used alone or in combination.

Of the polyalcohol components, the proportion of the aliphatic diol is preferably 80 mol percent or greater, and more preferably 90 mol percent or greater.

Polycarboxylic acids and/or polyalcohols can be optionally added in the last stage to adjust the acid value or the hydroxyl value.

Specific examples of the polycarboxylic acids include, but are not limited to, aromatic carboxylic acids such as terephthalic acid, isophthalic acid, phthalic anhydride, trimellitic anhydride, pyrromellitic acid, and naphthalene dicarboxylic acid; aliphatic carboxylic acids such as maleic anhydride, fumaric acid, succinic acid, alkenyl succinic anhydride, and adipic acid; and alicyclic carboxylic acids such as cyclohexane dicarboxylic acid.

Specific examples of the polyalcohols acids include, but are not limited to, aliphatic diols such as ethylene glycol, diethylene glycol, triethylene glycol, propylene glycol, butane diol, hexane diol, neopentyl glycol, and glycerin; alicyclic diols such as cyclohexane diol, cyclohexane dimethanol, and hydrogenerated bisphenol A; and aromatic diols such as adducts of bisphenol A with ethylene oxide, and adducts of bisphenol A with propylene oxide.

The crystalline polyester resin mentioned above can be manufactured at a polymerization temperature of from 18 to 230 degrees C. with optional processing such as reducing the pressure in a system and removing water and alcohol produced during the condensation.

It is suitable to add a solvent having a high boiling point as a dissolution helping solvent to solve a polymerizable monomer if it is not dissolved or compatible at reactive temperatures. The dissolution helping solvent is distilled away during the polycondensation reaction. For a poor compatible polymerizable monomer in copolymerization reaction, it is suitable to achieve condensation of the poor compatible polymerizable monomer with an acid or an alcohol for polycondensation with the poor compatible polymerizable monomer before the polycondensation with the main components.

Examples of the catalysts used for manufacturing the crystalline polyester resin mentioned above include, but are not limited to, alkali metal compounds such as sodium, and lithium; alkali earth metal compounds such as magnesium and calcium; metal compounds such as zinc, manganese, antimony, titanium, tin, zirconium, and germanium; phosphorous acid compounds; phosphoric acid compounds; and amine compounds.

Specific examples include, but are not limited to, sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabuthoxide, antimony trioxide, triphenyl antimony, tributyl antimony, tin formate, tetraphenyl tin, dibutyltin dichloride, dibutyl tin oxide, diphenyl tin oxide, zirconium tetrabuthoxide, zirconium naphthenate, zirconil carbonate, zirconil acetate, zirconil stearate, zirconil octylate, germanium oxide, triphenyl photophate, tris(2,4-di-t-butylphenyl)phosphate, ethyltriphenyl phosphonium, bromide, triethylamine, and triphenyl amine.

The acid value, which is the number of mg of KOH required to neutralize 1 g of resin, of the crystalline polyester resin is preferably from 3.0 to 30.0 mg/KOH, more preferably from 6.0 to 25.0 mg/KOH, and furthermore preferably from 8.0 to 20.0 mg/KOH.

The crystalline polyester resin preferably has a weight average molecular weight (Mw) is preferably from 6,000 to 35,000.

The weight average molecular weight can be measured by gel permeation chromatography (GPC). The molecular weight is measured by GPC using GPCHLC-8120 manufactured by TOSOH CORPORATION and column-TSKgel Super HM-M (15 cm), manufactured by TOSOH CORPORATION, as a measuring instrument, and THF solvent. The respective weight average molecular weights are calculated by using the molecular calibration curve made by the monodisperse polystyrene standard sample on a basis of the measuring results.

The crystalline resin containing the crystalline polyester resin preferably contains a crystalline polyester resin synthesized by an aliphatic polymerizable monomer as the main component, i.e., in an amount of 50 percent by mass or more. The composition ratio of the aliphatic polymerizable monomer forming the crystalline resin containing the crystalline polyester resin is preferably from 60 percent by mol or greater, and more preferably from 90 percent by mol of greater. Specific examples of the aliphatic polymerizable monomers include, but are not limited to, aliphatic diols and dicarboxyl acids.

Non-Crystalline Resin

The non-crystalline resin has no specific limit and can be suitably selected to suit to a particular application. Non-crystalline polyester resins are preferable.

Non-Crystalline Polyester Resin

The non-crystalline polyester resins are classified into modified polyester resins and non-modified polyester resins. It is more preferable to contain both.

Modified Polyester Resin

Examples of the modified polyester resin are as follows. It is possible to use polyester prepolymers having an isocyanate group. The polyester prepolymer (A) having an isocyanate group can be prepared by, for example, reacting a polyester having an active hydrogen group, which is a polycondensation product of a polyol (1) and a polycarboxylic acid (2), with a polyisocyanate (3). Specific examples of the active hydrogen group contained in the polyester mentioned above include, but are not limited to, hydroxyl groups (alcohol hydroxyl groups and phenol hydroxyl groups), amino groups, carboxylic groups, and mercarpto groups. Of these, alcohol hydroxyl groups are particularly preferred.

Modified polyester resins are obtained by reacting polyester prepolymer (A) having an isocyanate group with a cross-linking agent and/or an elongation agent.

Examples of the polyol (1) are diol (1-1) and polyol (triol or higher polyol) (1-2) and using diol (1-1) or a mixture of diol (1-1) with a small amount of (1-2) is preferred.

Specific examples of the diols include, but are not limited to, alkylene glycols (e.g., ethylene glycol, 1,2-propylene glycol, 1,3-propylene glycol, 1,4-butane diol, and 1,6-hexane diol); alkylene ether glycols (e.g., diethylene glycol, triethylene glycol, dipropylene glycol, polyethylene glycol, polypropylene glycol, and polytetra methylene ether glycol); alicyclic diols (e.g., 1,4-cyclohexane dimethanol, and hydrogen added bisphenol A); bisphenols (e.g., bisphenol A, bisphenol F and bisphenol S); and adducts of the bisphenols mentioned above with an alicyclic diol (ethylene oxide, propylene oxide and butylenes oxide). Alkylene glycols having 2 to 12 carbon atoms and adducts of bisphenol with alkylene oxide are preferable. Adducts of bisphenol with alkylene oxide and mixtures thereof with alkylene glycol having 2 to 12 carbon atoms are particularly preferable.

Specific examples of the polyols (1-2) include, but are not limited to, aliphatic acid alcohols having three or more hydroxyl groups (e.g., glycerin, trimethylol ethane, trimethylol propane, pentaerythritol and sorbitol); polyphenols having three or more hydroxyl groups (trisphenol PA, phenol novolak, and cresol novolak); and adducts of the tri-or higher polyphenols mentioned above with an alkylene oxide.

Suitable polycarboxylic acids (2) include, but are not limited to, dicarboxylic acids (2-1) and polycarboxylic acids (2-2) having three or more carboxyl groups. Of these, using the dicarboxylic acid (21) alone or a mixture of the dicarboxylic acid with a small amount of polycarboxylic acid (2-2) is preferable.

Specific examples of the dicarboxylic acids (2-1) include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid, and naphthalene dicarboxylic acid). Of these compounds, alkenylene dicarboxylic acids having 4 to 20 carbon atoms and aromatic dicarboxylic acids having 8 to 20 carbon atoms are preferable.

Specific examples of the polycarboxylic acids (2-2) having three or more hydroxyl groups include, but are not limited to, aromatic polycarboxylic acids having from 9 to 20 carbon atoms (e.g., trimellitic acid and pyrromellitic acid). Compounds prepared by reaction between anhydrides or lower alkyl esters (e.g., methyl esters, ethyl esters or isopropyl esters) of the polycarboxylic acids mentioned above and polyols (1) can be used as the polycarboxylic acid (2).

A suitable mixing ratio (i.e., an equivalence ratio [OH]/[COOH]) of a polyol (1) to a polycarboxylic acid (2) is from 2/1 to 1/1, preferably from 1.5/1 to 1/1, and more preferably from 1.3/1 to 1.02/1.

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α,α,α′,α′-tetramethyl xylylene diisocyanate); isocyanurates; and blocked polyisocyanates in which the polyisocyanates mentioned above are blocked with phenol derivatives thereof, oximes or caprolactams. These compounds can be used alone or in combination.

A suitable mixing ratio of the polyisocyanate (3) is represented by the equivalent ratio (i.e., [NCO]/[OH]) of isocyanate group [NCO] to hydroxyl group [OH] in a polyester having a hydroxyl group, which is, from 5/1 to 1/1, preferably from 4/1 to 1.2/1 and more preferably from 2.5/1 to 1.5/1.

The proportion of the constitutional component of a polyisocyanate (PIC) (3) in the isocyanate group-terminated polyester prepolymer (A) is from 0.5 to 40 percent by mass, preferably from 1 to 30 percent by mass, and more preferably from 2 to 20 percent by mass.

The number of isocyanate groups included in the prepolymer (A) per molecule is normally not less than 1, preferably from 1.5 to 3, and more preferably from 1.8 to 2.5 on average.

Cross Linking Agent and Elongation Agent

Amines can be used as an elongation agent and/or a cross linking agent.

Specific examples of the amines (B) include, but are not limited to, diamines (B1), polyamines (B2) having three or more amino groups, amino alcohols (B3), amino mercaptans (B4), amino acids (B5), and blocked amines (B6) in which the amines (B1) to (B5) mentioned above are blocked.

Specific examples of the diamines (B1) include, but are not limited to, aromatic diamines (e.g., phenylene diamine, diethyltoluene diamine, and 4,4′-diaminodiphenyl methane); alicyclic diamines (e.g., 4,4′-diamino-3,3′-dimethyldicyclohexyl methane, diaminocyclohexane and isophoron diamine); and aliphatic diamines (e.g., ethylene diamine, tetramethylene diamine, and hexamethylene diamine).

Specific examples of the polyamines (B2) having three or more amino groups include, but are not limited to, diethylene triamine and triethylene tetramine.

Specific examples of the amino alcohols (B3) include, but are not limited to, ethanol amine and hydroxyethyl aniline.

Specific examples of the amino mercaptan (B4) include, but are not limited to, aminoethyl mercaptan and aminopropyl mercaptan.

Specific examples of the amino acids (B5) include, but are not limited to, amino propionic acid and amino caproic acid.

Specific examples of the blocked amines (B6) include, but are not limited to, ketimine compounds which are prepared by reacting one of the amines (B1) to (B5) mentioned above with a ketone such as acetone, methyl ethyl ketone and methyl isobutyl ketone; and oxazoline compounds.

Of these, (B1) and a mixture of (B1) with a small amount of (B2) are preferable.

The molecular weight of the modified polyesters after the reaction can be controlled optionally using a terminating agent to stop cross linking and/or elongation. Specific examples of the terminating agent include, but are not limited to, monoamines (e.g., diethyl amine, dibutyl amine, butyl amine and lauryl amine), and blocked amines (i.e., ketimine compounds) prepared by blocking the monoamines mentioned above.

The proportion of the isocyanate group to the amines (B), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5, and more preferably from 1.2/1 to 1/1.2.

Non-Modified Polyester Resin

It is suitable to contain a non-modified polyester resin (C) as a toner binder component together with this (A) in addition to the sole use of the modified polyester resin (A). This combinational use of (C) enhances the low temperature fixability and gloss and gloss evenness when used in a full color apparatus.

Polycondensation products formed of the same polyol (1) and the same polycarboxylic acid (2) as those for the polyester components of the (A) can be used as the (C) and the preferred examples are the same as those for (A). A polyester modified by a bonding (e.g., urethane bonding) other than urea bonding can be used as the polyester (C) in addition to unmodified polyesters.

It is preferable that the (A) and the (C) are at least partially compatible with each other for enhancing the low temperature fixability and the hot offset resistance. Therefore, the polyester component of (A) preferably has an analogous component to the (C). The mass ratio of the (A) to the (C) is from 5/95 to 75/25, preferably from 10/90 to 25/75, more preferably from 12/88 to 25/75, and particularly preferably from 12/88 to 22/78 when the (A) is contained.

The peak molecular weight of the (C) is from 1,000 to 30,000 and preferably from 1,500 to 10,000 and more preferably from 2,000 to 8,000.

The acid value of the (C) is from 0.5 to 40 mg/KOH and preferably from 5 to 35 mg/KOH. Produced toner having an acid value tends to have a negative chargeability.

The glass transition temperature of the toner has no particular limit and can be suitably selected to suit to a particular application. It is preferably from 40 to 70 degrees C. and more preferably from 45 to 55 degrees C.

Coloring Agent

Typical dyes and pigments can be used as the coloring agent. Specific examples thereof include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The proportion of the coloring agent in the toner is not particularly limited and can be suitably selected to suit to a particular application. It is preferably from 1 to 15 percent by mass and more preferably from 3 to 10 percent by mass to the toner.

The coloring agent can be used as a composite master batch with a resin.

The master batch can be prepared by mixing and kneading a resin and a coloring agent for a master batch under high shear stress thereto. In this case, an organic solvent can be used to boost the interaction between the coloring agent and the resin. In the flushing method, an aqueous paste including water of a coloring agent is mixed with a resin and an organic solvent to transfer the coloring agent to the resin solution and then the aqueous liquid and organic solvent are removed. This method is preferably used because the resulting wet cake of the coloring agent can be used as it is. In this case, a high shear dispersion device such as a three-roll mill can be preferably used for kneading the mixture.

Releasing Agent

The toner may optionally furthermore contain a releasing agent (represented by wax) in addition to a binder resin and a coloring agent.

Any known releasing agent can be suitably used. Specific examples of the releasing agent include, but are not limited to, polyolefin waxes such as polyethylene waxes and polypropylene waxes; long chain hydrocarbons such as paraffin waxes and SAZOL waxes; and waxes including a carbonyl group. Of these waxes, waxes including a carbonyl group are preferable.

There is no specific limit to the melting point of the releasing agent. The melting point is preferably from 40 to 160 degrees, more preferably from 50 to 120 degrees C., and particularly preferably from 60 to 90 degrees C.

The releasing agent preferably has a melt viscosity of from 5 to 1000 cps and more preferably from 10 to 100 cps as the measuring values at the temperature 20 degrees C. higher than the melting point of the releasing agent.

The proportion of the releasing agent in a toner is not particularly limited and can be suitably selected to suit to a particular application. It is preferably from 0 to 40 percent by mass and more preferably from 3 to 30 percent by mass.

Charge Control Agent

The toner may furthermore optionally contain a charge control agent.

Specific examples of the charge control agent include, but are not limited to, known charge control agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and metal salts of salicylic acid derivatives.

The proportion of the charge control agent in a toner is determined depending on the type of the binder resin, whether or not an additive is optionally added and the method of manufacturing toner including a dispersion method so that it is not unambiguously defined. The proportion of the charge control agent is preferably from 0.1 to 10 parts by mass to 100 parts by mass of a binder resin. More preferably, it is from 0.2 to 5 parts by mass. These charge control agents can be melted and dispersed after they are melt-kneaded with a master batch and a resin. Alternatively, they can be directly added when dissolved or dispersed in an organic solvent. Alternatively, they can be fixed on the surface of toner particles after the particles are formed.

External Additive

External additives such as oxide particulates can be added for enhancing fluidity, developability, and chargeability of mother toner particles. Inorganic particulate and hydrophobized inorganic particulates are preferably used in combination. It is preferable to contain at least one type of hydrophobized inorganic particulates preferably having an average primary particle diameter of from 1 to 100 nm and more preferably, from 5 to 70 nm. Furthermore, it is more preferable to contain at least one type of hydrophobized inorganic particulates having an average primary particle diameter of 20 nm or less and at least one type of hydrophobized inorganic particulates having an average primary particle diameter of 30 nm or less. The specific surface as measured by BET method is preferably from 20 to 500 m²/g.

It is possible to use any known inorganic particulate as long as they satisfy the conditions mentioned above. Such inorganic particulates include silica particulates, metal salts of aliphatic acids such as zinc stearate and aluminum stearate), metal oxides such as titania, alumina, tin oxide, and antimony oxide, and fluoropolymers.

Hydrophobized silica, titania, titanium oxide, and alumina particulates are particularly preferable.

Specific examples of the silica particulates include, but are not limited to, HDK H 2000, HDK H 2000/4, HDK H 2050 EP, HVK21, and HDK H 1303, (all manufactured by Hoechst Ag), and R972, R974, RX200, RY200, R202, R805, and R812 (all manufactured by Nippon Aerosil Co., Ltd.) Specific examples of the titania particulates include, but are not limited to, P-25 (manufactured by Nippon Aerosil Co., Ltd.), STT-30 and STT-65C-S (manufactured by Titan Kogyo, Ltd.), TAF-140 (manufactured by FUJI TITANIUM INDUSTRY CO., LTD.), and MT-150W, MT-500B, MT-600B, and MT-150A (manufactured by Tayca Corporation). Specific examples of the hydrophobized titanium oxide particulates include, but are not limited to, T-805 (manufactured by Nippon Aerosil Co., Ltd.), STT-30A, STT-65S-S (manufactured by Titan Kogyo, Ltd.), TAF-500T and TAF-1500T (manufactured by FUJI TITANIUM INDUSTRY CO., LTD.), MT-100S and MT-100T (manufactured by Tayca Corporation), and IT-S (manufactured by ISHIHARA SANGYO KAISHA, LTD.)

It is possible to obtain silica particulates, titania particulates, and alumina particulates as hydrophobized oxide particulate by subjecting hydrophilic particulates to treatment with a silane coupling agent such as methyl trimethoxyxilane, methyltriethoxy silane, and octyl trimethoxysilane. Silicon oil-treated oxide particulates and inorganic particulates, which are optionally treated with heated silicone oil, are also preferable.

The proportion of the external additive is not particularly limited and can be suitably selected to suit to a particular application. It is preferably from 0.1 to 5 percent by mass and more preferably from 0.3 to 3 percent by mass to the toner.

A cleaning property improver is used to remove a developing agent remaining on an image bearer or a primary transfer medium after transfer. It includes stearic acid, aliphatic metal salts, for example, zinc stearate and calcium stearate, and polymer particulates manufactured by soap-free emulsification polymerization such as polymethyl methacrylate particulates and polystyrene particulates. Such polymer particulates preferably have a relatively sharp particle size distribution and a volume average particle diameter of from 0.01 to 1 μm.

Resin Particulate

The toner may furthermore optionally contain resin particulates.

The glass transition temperature (Tg) of the resin particulate has no particular limit and can be suitably selected to suit to a particular application. It is preferably from 40 to 100 degrees C.

The weight average particle diameter of the resin particulate has no particular limit and can be suitably selected to suit to a particular application. It is preferably from 3.00 to 300,000.

Resins capable of forming an aqueous dispersion can be used as the resin particulate and include thermoplastic resins and thermocurable resins.

Specific examples include, but are not limited to, vinyl-based resins, polylactic resins, polyurethane resins, epoxy resins, polyester resins, polyamide resins, polyimide resins, silicone resins, phenolic resins, melamine resins, urea resins, aniline resins, ionomer resins, and polycarbonate resins.

These can be used alone or in combination. Of these resins, vinyl-based resins, polyurethane resins, epoxy resins, polyester resins, and mixtures thereof are preferably used because an aqueous dispersion including fine spherical particulates can be readily prepared.

Specific examples of the vinyl-based resins include, but are not limited to, polymers, which are prepared by polymerizing a vinyl monomer or copolymerizing vinyl monomers, such as styrene-(meth)acrylate resins, styrene-butadiene copolymers, (meth)acrylic acid-acrylate copolymers, styrene-acrylonitrile copolymers, styrene-maleic anhydride copolymers, and styrene-(meth)acrylic acid copolymers.

Method of Manufacturing Toner

The method of manufacturing toner is not particularly limited and can be suitably selected to suit to a particular application. It can be a wet or dry method. One way of manufacturing toner in an aqueous medium is described below as an example of manufacturing a toner. The method of manufacturing toner for use in the present disclosure is not limited thereto; the toner can be manufactured by a known method such as a so-called emulsification agglomeration or pulverization method.

Method of Manufacturing Toner in Aqueous Medium

It is preferable to add resin particulates to an aqueous phase in advance. The resin particulate serves as a particle diameter control agent and is arranged around toner particles; it functions as a shell layer covering the surface of the toner particles. In order to sufficiently function the shell layer, a detailed control is required because the function is affected by the particle diameter, composition, dispersant, i.e., surfactant, in an aqueous medium, and solvents.

Water for use in the aqueous medium (aqueous phase) is not limited to simple water; a mixture of water with a solvent miscible with water can used in combination.

Specific examples of such miscible solvents include, but are not limited to, alcohols (e.g., methanol, isopropanol, and ethylene glycol), dimethylformamide, tetrahydrofuran, cellosolves (e.g., methyl cellosolve), and lower ketones (e.g., acetone and methyl ethyl ketone).

One way of manufacturing toner particles is to react a dispersion constituted of the polyester prepolymer (A) having an isocyanate group dissolved or dispersed in an organic solvent in an aqueous medium with the amine (B).

One way of stably forming a dispersion constituted of the polyester prepolymer (A) is to add a toner material containing the polyester prepolymer (A) dissolved or dispersed in an organic solvent to an aqueous medium followed by applying a shearing force thereto.

It is possible to mix the polyester prepolymer (A) dissolved or dispersed in an organic solvent and other toner compositions (hereinafter referred to as toner material) including a coloring agent, a master batch of coloring agent, a releasing agent, a charge control agent, and a non-modified polyester resin can be mixed when a dispersion is formed in an aqueous phase; it is, however, preferable to mix the toner material and dissolve or disperse it before the mixture is added to an aqueous phase for dispersion. The other toner material such as a coloring agent, a releasing agent, and a charge control agent are not necessarily mixed before the particles are formed in an aqueous medium but can be added after the particles are formed in an aqueous medium. For example, after particles containing no coloring agent are formed, a coloring agent is added thereto by a known dying method.

There is no particular limit to the dispersion method. These can be dispersed by a method such as a low speed shearing method, high speed shearing method, friction method, high pressure jet method, and ultrasonic method. Of these methods, the high speed shearing method is preferable because a dispersion having a particle diameter of from 2 to 20 μm can be readily prepared. When a high speed shearing type dispersion machine is used, there is no particular limitation to the rate of rotation thereof. It is normally from 1,000 to 30,000 rpm and preferably from 5,000 to 20,000 rpm. T here is no specific limit to the dispersion time; it is typically from 0.1 to 5 minutes in the batch system. The temperature during dispersion is typically from 0 to 150 degrees C. (under pressure) and preferably from 40 to 98 degrees C. High temperatures are preferable during dispersion because the viscosity of the dispersion containing the polyester prepolymer (A) is low, which is advantageous for dispersion.

The number of parts of the aqueous phase to 100 parts of a toner composition containing the polyester prepolymer (A) is not particularly limited and can be suitably selected to suit to a particular application. It is from 50 to 2,000 parts and preferably from 100 to 1,000 parts. It is allowed to use a dispersant. It is preferable to use a dispersant because the particle size distribution becomes sharp and dispersion is stabilized.

An inorganic compound such as tricalcium phosphate, calcium phosphate, titanium oxide, colloidal silica, and hydroxyapatite can also be used as the inorganic compound dispersant little or never soluble in water.

The use of a polymer protection colloid can stabilize the liquid droplet dispersion in an aqueous medium.

When compounds such as calcium phosphate soluble in an acid or alkali are used as a dispersion stabilizer, resulting particulates are purged of calcium phosphate by a process such as rinsing with water after it is dissolved in an acid such as a hydrochloric acid. It can be removed by an operation such as a zymolytic method.

Such a dispersant may remain on the surface of toner particles. However, it is preferable to purge the surface of the dispersant by rinsing after elongation and/or cross-linking reaction is complete.

The cross-linking time and/or the elongation time is determined depending on the reactivity determined according to the combination of the isocyanate group structure of the prepolymer (A) and the amine (B). It is typically from 10 minutes to 40 hours, and preferably from 2 to 24 hours. The reaction temperature is from 0 to 150 degrees C. and preferably from 40 to 98 degrees C. It is allowed to use a known catalyst on a necessity basis. Specific examples thereof include, but are not limited to, dibutyl tin laurate, and dioctyl tin laurate.

One method of removing the organic solvent from the thus prepared emulsion dispersion is to completely evaporate and remove the organic solvent in the droplets by gradually raising the temperature of a system. Another way is to form toner particulates by spraying an emulsion dispersion in a dried atmosphere for removing the non-water-insoluble organic solvent in liquid droplets together with an aqueous dispersant. The dry atmosphere into which an emulsified dispersion is sprayed is obtained by heating air, nitrogen, carbon dioxide gas, and combustion gases. The air stream heated to temperatures higher than the highest boiling point of all of the solvents in the emulsion dispersion is normally used. Drying treatment with a drying device such as a spray dryer, a belt dryer, and a rotary kiln in a short time is sufficient to obtain desired quality.

The organic solvent can be removed by blowing air into an emulsion dispersion with a device such as a rotary evaporator.

Subsequent to coarse separation by centrifugal, the solvent is removed and dried by repetitively rinsing and drying the emulsion dispersion in a rinsing tank and by a heated wind drier to obtain mother toner.

Thereafter, it is preferable to add an aging process. It is preferable to age the mother toner in a temperature range of from 30 to 55 degrees C. (more preferably from 40 to 50 degrees C.) for preferably from 5 to 36 hours (more preferably from 10 to 24 hours).

When the thus prepared toner particles still have a wide particle size distribution after the rinsing and drying treatment, the particle size distribution can be adjusted by a classification treatment to obtain a desired particle size distribution.

Fine particles can be removed in liquid by classification using a device such as a cyclone, a decanter, or a centrifugal. It is possible to classify mother powdered toner obtained after it is dried; it is, however, preferable to classify it in liquid to better efficiency. Obtained unnecessary toner particulates or coarse particles can be returned to the mixing and kneading process for reuse even when the toner particulates or coarse particles are in a wet condition.

It is preferable to purge the liquid dispersion of the dispersant used as much as possible and is preferably removed simultaneously in the classification process.

The thus prepared toner powder particles can be mixed with other fine particles such as releasing agent particles, charge control agent particles, fluidizing agent particles, and coloring agent particles. Such fine particles can be fixed on the surface of toner particles by applying a mechanical impact thereto while the particles and toner particles are integrated. Thus, the fine particles can be prevented from being detached from the toner particles.

Specific examples of such mechanical impact application methods include, but are not limited to, a method in which an impact is applied to a mixture by a blade rotating at a high speed and a method of putting a mixture into a jet air stream to accelerate the speed of (complex) particles to collide each other or with a collision plate.

Specific examples of such mechanical impact applicators include, but are not limited to, ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTRON SYSTEM (manufactured by Kawasaki Heavy Industries, Ltd.), automatic mortars, etc.

The toner is mixed with external additives such as inorganic particulates with a machine such as a Henschel Mixer followed by removing coarse particles with an ultrasonic wave sieve to obtain toner as a product.

Carrier for Two Component Developing Agent

Magnetic carrier is mixed with toner to make a two-component developing agent. The number of parts of the toner to 100 parts of carrier in the two-component developing agent is preferably from 1 to 10 parts by mass.

Known products such as ferrite powder, magnetite powder, and magnetic resin carrier having a particle diameter of from 20 to 200 μm can be used as the magnetic carrier.

Specific examples of materials for covering carrier include, but are not limited to, amino-based resins such as urea-formaldehyde resins, melamine resins, benzoguanamine resins, urea resins, polyamide resins, and epoxy resins. Other specific examples include, but are not limited to, polyvinyl or polyvinylidene resins, for example, acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins, for example, polyvinyl chloride resins, polyester resins, for example, polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, fluoroterpolymers, for example, a copolymer of tetrafluoroethylene, fluorovinylidene, and a fluorine-free monomer, and silicone resins.

The resin for covering may optionally contain electroconductive powder. Specific examples of such electroconductive powder include, but are not limited to, metal powder, carbon blacks, titanium oxide, tin oxide, and zinc oxide. The average particle diameter of such electroconductive powder is preferably 1 μm or greater. When the average particle diameter is too large, controlling electric resistance may become difficult.

The toner can be used as a magnetic or non-magnetic single-component toner not containing carrier.

Tandem Color Image Forming Apparatus

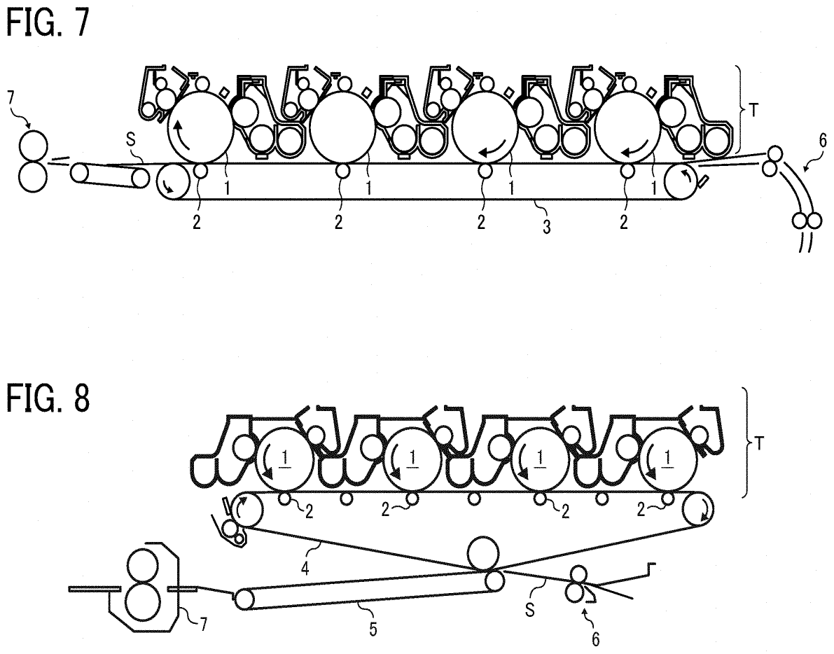

The image forming apparatus of the present disclosure may have a tandem configuration having at least four or more developing units arranged in serial each having different developing color. One embodiment of the tandem color image forming apparatus is described below. There are two types of tandem image forming apparatuses. One employs a direct transfer system in which images on each image bearer 1 are sequentially transferred to sheets S conveyed by a sheet conveyor belt 3 by a transfer deice 2 as illustrated in FIG. 7; and the other employs an indirect transfer system in which images on each image bearer 1 are temporarily and sequentially transferred to an intermediate transfer member 4 by a primary transfer device 2 and then the image on the intermediate transfer member 4 is transferred at once by a secondary transfer device 5 to sheets S as illustrated in FIG. 8. The transfer device 5 is a transfer conveyor belt but may take a roller form.

In comparison with the direct transfer system and the indirect transfer system, the former is necessary to dispose a feeding device 6 upstream of a tandem image forming unit T having image bearers 1 arranged in a tandem manner and a fixing device 7 downstream of the tandem image forming unit T. This is disadvantageous because the image forming apparatus becomes large in the sheet conveying direction.

On the other hand, the latter relatively has a freedom of latitude for the secondary transfer position.

The feeding device 6 and the fixing device 7 can be disposed overlapping with the tandem image forming unit T, which is advantageous to decrease the size of the image forming apparatus.

In the former, the fixing device 7 is disposed close to the tandem image forming unit T to avoid an increase of the size. For this reason, it is not possible to dispose the fixing device 7 allowing a sufficient room for bending of the sheet S; this configuration may adversely affect image formation conducted upstream by the fixing device 7 owing to an impact, in particular thick sheets, when the front end of the sheet S enters into the fixing device 7 and the speed difference between the sheet conveyance speed when the sheet S passes the fixing device 7 and the sheet conveyance speed by the transfer conveyor belt.

Conversely, since the latter can have a configuration having a sufficient room for bending of the sheet S when it comes to the positioning the fixing device 7; the fixing device has little impact on image formation.

The indirect transfer system in particular is appealing because of the points mentioned above.

As illustrated in FIG. 8, this type of the color image forming apparatus removes toner remaining on the image bearer 1 after the primary transfer by cleaning the surface of the image bearer 1 with a cleaning device 8 for the image bearer 1 to make the image forming apparatus ready for the next image forming operation. Toner remaining on the intermediate transfer member 4 after the secondary transfer is removed with an intermediate cleaning device by cleaning the surface of the intermediate transfer member 4 to make the image forming apparatus ready for the next image forming operation.

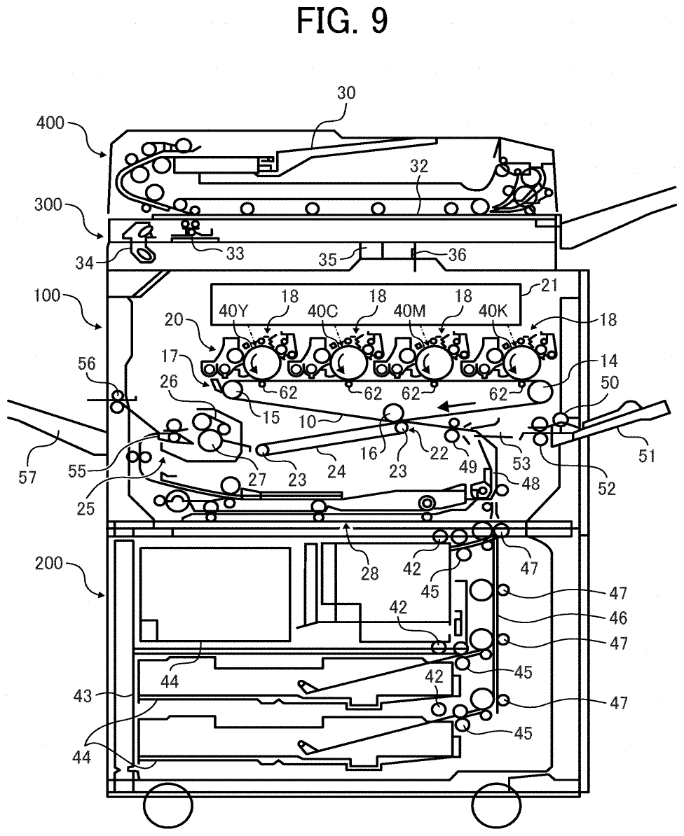

FIG. 9 is a diagram illustrating an embodiment of the present disclosure, the image forming apparatus employing a tandem transfer system. The reference numerals 100, 200, 300, and 400 in FIG. 9 respectively represent a photocopying unit, a sheet feeding table carrying the photocopying unit 100, a scanner mounted onto the photocopying unit 100, and an automatic document feeder (ADF) further mounted onto the scanner 300. The photocopying unit 100 has an intermediate transfer member 10 having an endless form at the center thereof.

As illustrated in FIG. 9, the intermediate transfer member 10 is stretched between a first supporting roller 14, a second supporting roller 15, and a third supporting roller 16 to render the intermediate transfer member 10 rotatable clockwise.

In this drawing, there is provided an intermediate transfer member cleaning device 17 on the left side of the second supporting roller 15 of the three rollers to remove residual toner remaining on the intermediate transfer member 10 after image transfer.

Four image forming units 18 of yellow, cyan, magenta, and black are disposed side by side along the conveying direction on the intermediate transfer member 10 stretched between the first supporting roller 14 and the second supporting roller 15 of the three rollers to constitute a tandem image forming device 20.

As illustrated in FIG. 9, an irradiator (exposing device) 21 is disposed above the tandem image forming device 20. A secondary transfer device 22 is disposed on the opposite side of the therebetween. In the drawing, the secondary transfer device 22 includes a secondary transfer belt 24 having an endless form stretched between two rollers 23 and is disposed pressed against the third supporting roller 16 with the intermediate transfer member 10 therebetween to transfer the image on the intermediate transfer member 10 to a transfer sheet (recording medium).

A fixing device 25 is disposed to fix the transferred image on the sheet alongside of the secondary transfer device 22. The fixing device 25 includes a fixing belt 26 having an endless form and a pressure roller 27 pressed against the fixing belt 26.

The secondary transfer device 22 assumes function of conveying the sheet to the fixing device 25 after the image transfer. A transfer roller or a non-contact type charger can be disposed as the secondary transfer device 22; however, such a secondary transfer device is difficult to have this sheet transfer function.

In the illustrated embodiment, a sheet reversing device 28 for reversing the sheet to record images on both sides thereof is arranged below the secondary transfer device 22 and the fixing device 25 and in parallel with the tandem image forming device 20.

To make a photocopy using this color image forming apparatus, a manual is set on a document table 30 of the automatic document feeder 400. Alternatively, the automatic document feeder 400 is opened to set a document on a contact glass 32 for the scanner 300, and thereafter the automatic document feeder 400 is closed to press the document therewith.

When the start button is pressed, the scanner 300 is driven to scan the document on the contact glass 32 with a first scanning unit 33 and a second scanning unit 34 after the document is moved to the automatic document feeder 400 in the case in which the document is set on the automatic document feeder 400 or immediately when the document is set on the contact glass 32. The first scanning unit 33 reflects the light emitted from the light source to the original document and again reflects the reflected light to the second scanning unit 34. The second scanning unit 34 reflects the light with its mirror to a reading sensor 36 via a focusing lens 35 for reading the image information.

When the starting switch is pressed, a driving motor rotationally drives one of supporting rollers 14, 15 and 16 and thus the other two supporting rollers are rotationally driven to rotate the intermediate transfer member 10. At the same time, individual image forming units 18 drive the photoconductors 40 to form individual single color images of black, yellow, magenta, and cyan. In synchronization with the rotation of the intermediate transfer member 10, these single color toner images are sequentially transferred to the intermediate transfer member 10 for forming a synthesized color image thereon.

One of the sheet feeder rollers 42 in the sheet feeder table 200 is selectively rotated to bring up a recording medium (sheet) from one of multiple sheet cassettes 44 stacked in a sheet bank 43 when the start button is pressed. A separating roller 45 separates the recording media one by one to feed it to a sheet path 46. Conveying rollers 47 convey and guide the recording medium to a sheet path 48 in the photocopying unit 100 and the recording medium is blocked at a registration roller 49.

Alternatively, the sheet on a manual feeder tray 51 are fed by rotating a paper feeder roller 50 and detached one by one by a detaching roller 52. The sheet is fed into a manual feeding path 53, blocked at the registration roller 49 and stops.

The registration roller 49 is rotated in synchronization with the synthesized color image on the intermediate transfer member 10 to feed the sheet between the intermediate transfer member 10 and the secondary transfer device 22, where the image is transferred to the sheet by the secondary transfer device 22.

After image transfer, the sheet is sent by the secondary transfer device 22 to a fixing device 25, where heat and pressure are applied to the sheet to fix the image thereon. Thereafter, a switching claw 55 is thrown to eject the sheet by ejection rollers 56. Alternatively, the switching claw is thrown to enter the sheet into a sheet reversing device 28, where the sheet is reversed and guided to the transfer position again. After another image is recorded on the other side of the sheet, the ejection roller 56 ejects the sheet onto the ejection tray 57.

The residual toner on the intermediate transfer member 10 is removed by an intermediate transfer member cleaning device 17 after image transfer to make the tandem image forming device 20 ready for the next image formation.

The registration roller 49 is typically grounded but a bias can be applied thereto to remove paper dust on the sheet.

In the tandem image forming device 20, each of the individual image forming units 18 has a charging device, a developing device, a primary transfer device 61, a cleaner for a photoconductor, and a quencher around a drum photoconductor 40.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. “Parts” represents percent by mass unless otherwise specified. “Percent” represents percent by mass unless otherwise specified.

Evaluation Apparatus A

A RICOH imagio MP C5002 having a remodeled developing unit and fixing unit was used as an evaluation apparatus. What was remodeled was all of the units for development, transfer, cleaning, and conveyance; they were changed or adjusted to achieve a linear speed of 400 mm/s. The development gap was set to be 1.26 mm and the doctor blade gap was set to be 1.6 mm with a reflection type photosensor function off. The fixing unit was set to have a fixing surface pressure of 1 N/cm² and a fixing nip width of 10 mm. Tetrafluoroethylene-perfluoroalkyl vinyl ether (PTA) resin was applied to the surface of the fixing medium followed by molding and surface adjustment treatment. The belt member of the fixing medium was set to have an elastic layer having a thickness of 200 μm disposed between the substrate layer and the surface layer. The actual temperatures at the image bearer, the development device, and the transfer device were set to be between 30 to 45 degrees C. The heating fixing temperature was set to be 140 degrees C. (FIG. 2).

Evaluation Apparatus B

A RICOH imagio MP C5002 having a remodeled developing unit and fixing unit was used as an evaluation apparatus. All of the units for development, transfer, cleaning, and conveyance was remodeled to achieve a linear speed of 400 mm/s. The development gap was set to be 1.26 mm and the doctor blade gap was set to be 1.6 mm with a reflection type photosensor function off. The fixing unit was set to have a fixing surface pressure of 0.5 N/cm² and a fixing nip width of 13 mm. Tetrafluoroethylene-perfluoroalkyl vinyl ether (PTA) resin was applied to the surface of the fixing medium followed by molding and surface adjustment treatment. The belt member of the fixing medium was set to have an elastic layer having a thickness of 500 μm disposed between the substrate layer and the surface layer. The actual temperatures at the image bearer, the development device, and the transfer device were set to be between 30 to 45 degrees C. The heating fixing temperature was set to be 140 degrees C. (FIG. 2).

Evaluation Apparatus C for Comparison

A RICOH imagio MP C600 Pro having a remodeled mainly developing unit and fixing unit was used as an evaluation apparatus. All of the units for development, transfer, cleaning, and conveyance was remodeled to achieve a linear speed of 400 mm/s. The fixing unit was set to have a fixing surface pressure of 1 N/cm² and a fixing nip width of 10 mm. The actual temperatures at the image bearer, the development device, and the transfer device were set to be between 30 to 45 degrees C. The heating fixing temperature was set to be 140 degrees C.

The fixing system includes a pressing member for pressing a recording medium to a heating member having a roller form not planar form via a belt member while indirectly heating the belt member with the heating member to form a toner image on the recording medium. One example of the heating member is illustrated as the heating roller 32 in FIG. 2 of Japanese Unexamined Patent Application Publication No. 2016-109901.

Evaluation on Two Component Developing Agent

Ferrite carrier having an average particle diameter of 30 μm coated with a silicone resin with a thickness of 0.4 μm on average was used for evaluation on images developed with a two component developing agent. Uniformly charged developing agent was prepared in a turbular mixer by stirring and mixing toner and the carrier while rolling the mixer with a proportion of each color toner at 7 parts by mass to the ferrite carrier at 100 parts by mass.

### Manufacturing of Carrier

Core Material

Mn ferrite particles (weight average particle diameter of 30 μm: 5,000 parts

Coating Material

Toluene: 450 parts

Silicone resin (SR2400, non-volatile portion of 50 percent, manufactured by Dow Corning Toray Co., Ltd.): 450 parts

Aminosilane (SH6020, manufactured by Dow Corning Toray Co., Ltd.): 10 parts

Carbon black: 10 parts

The coating material was dispersed by a stirrer for ten minutes to prepare a coating liquid. This coating liquid and the core material were loaded in a coating device for forming a swirl flow with a rotation base plate disk and a stirring wing in a fluidizing bed to apply the coating liquid to the core material. The thus-obtained application matter was baked at 250 degrees C. in an electric furnace at 250 degrees C. for two hours to obtain the carrier mentioned above.

### Example 1

Manufacturing of Toner

Synthesis of Resin Particulate Emulsion

The following recipe was placed in a reaction container equipped with a stirrer and a thermometer and stirred at 3,800 rpm for 30 minutes to obtain a white emulsion:

Water: 683 parts

Sodium salt of sulfuric acid ester of an adduct of methacrylic acid with ethylene oxide (EREMINOR RS-30, manufactured by Sanyo Chemical Industries, Ltd.): 11 parts

Polylactic acid: 5 parts

Polyglycol: 5 parts

Styrene: 60 parts

Methacrylic acid: 100 parts

Butyl acrylate: 70 parts

Ammonium persulfate: 1 part.

The system was heated to 75 degrees C. for reaction for four hours. Furthermore, 30 parts of ammonium persulfate aqueous solution at 1 percent was added followed by aging at 75 degrees C. for six hours to obtain an aqueous liquid dispersion of [particulate liquid dispersion 1] of a vinyl-based resin (copolymer of sodium salt of sulfuric acid ester of styrene-methacrylic acid-butyl acrylate-an adduct of methacrylic acid with ethylene oxide. [Particulate liquid dispersion 1] had a volume average particle diameter of 140 nm as measured by LA-920. The resin portion was isolated by drying a portion of [particulate liquid dispersion 1]. The resin portion had a glass transition temperature (Tg) of 61 degrees C. and a weight average molecular weight of 70,000.

Preparation of Aqueous Phase

A total of 990 parts of water, 83 parts of [particulate liquid dispersion 1], 37 parts of aqueous solution of sodium dodecyldiphenyl etherdisulfonate (EREMINOR MON-7, manufactured by Sanyo Chemical Industries, Ltd.) at 48.3 percent, and 90 parts of ethyl acetate were mixed and stirred to obtain milk white liquid. This was determined as [aqueous phase 1].

Synthesis of Polyester Having Small Molecular Weight

The following components are placed in a reaction container equipped with a condenser, a stirrer, and a nitrogen introducing tube to conduct reaction at 230 degrees C. at normal pressure for 7 hours followed by 5 hour reaction with a reduced pressure of 10 mmHg to 15 mmHg:

Adduct of bisphenol A with 2 mols of ethylene oxide: 229 parts

Adduct of bisphenol A with 3 mols of propylene oxide: 329 parts

Terephthalic acid: 208 parts

Trimellitic anhydride: 80 parts

Dibutyl tin oxide: 2 parts

Thereafter, 35 parts of trimellitic anhydride was put into the reaction container to conduct reaction at 180 degrees C. and normal pressure for 5 hours to obtain [low molecular weight polyester 1]. [Low molecular weight polyester 1] had a number average molecular weight of 2,800, a weight average molecular weight of 4,300, a glass transition temperature of 43 degrees C., and an acid value of 25 mgKOH/g.

Synthesis of Intermediate Polyester

The following components were placed in a container equipped with a condenser, a stirrer and a nitrogen introducing tube to conduct reaction at 230 degrees C. under normal pressure for 8 hours followed by another reaction for 7 hours with a reduced pressure of 10 mmHg to 15 mmHg to synthesize [intermediate polyester 1]:

Adduct of bisphenol A with 2 mols of ethylene oxide: 682 parts

Adduct of bisphenol A with 2 mols of propylene oxide: 81 parts

Terephthalic acid: 283 parts

Trimellitic anhydride: 22 parts

Dibutyl tin oxide: 2 parts

The obtained [intermediate polyester 1] had a number average molecular weight of 2,800, a weight average molecular weight of 10,600, a glass transition temperature of 55 degrees C., an acid value of 0.5 mgKOH/g, and a hydroxyl value of 52 mgKOH/g.

Next, 410 parts of [intermediate polyester 1], 89 parts of isophorone diisocyanate, and 500 parts of ethyl acetate were placed in a reaction container equipped with a condenser, a stirrer and a nitrogen introducing tube to conduct reaction at 100 degrees C. for 7 hours to obtain [prepolymer 1]. The obtained [prepolymer 1] had an isolated isocyanate in an amount of 1.53 percent by mass.

Synthesis of Ketimine

A total of 170 parts of isophoronediamine and 75 parts of methyl ethyl ketone were placed in a reaction container equipped with a stirrer and a thermometer to conduct reaction at 50 degrees C. for five and a half hours to obtain [ketimine compound 1]. [Ketimine compound 1] had an amine value of 417.

Synthesis of Master Batch (MB)

A total of 1,200 parts of water, 540 parts of carbon black (Printex 35, manufactured Degussa AG, DBP oil absorption amount: 42 ml/100 mg, PH: 9.5), and 1,200 parts of polyester resin were mixed by a Henschel Mixer (manufactured by NIPPON COKE & ENGINEERING.

CO., LTD.). The mixture was then kneaded at 110 degrees C. for one hour using two rolls and thereafter rolled and cooled down followed by pulverization by a pulverizer to obtain [master batch 1].

Synthesis of Crystalline Polyester

A total of 1,200 parts of 1,6-hexane diol, 1,200 parts of dodecanedioic acid, and 0.4 parts of dibutyl tin oxide as a catalyst were placed in a reaction container equipped with a condenser, a stirrer, and a nitrogen introducing tube and then the air in the container was replaced with nitrogen gas with a reduced pressure followed by mechanical stirring at 180 rpm for five hours. Subsequent to gradually raising the temperature of the system to 200 degrees C. with a reduced pressure followed by a two and half hour stirring, the resulting matter was cooled down when it became tenacious to terminate the reaction to obtain [crystalline polyester 1]. [Crystalline polyester 1] had a number average molecular weight of 4,200, a weight average molecular weight of 16,000, and a melting point of 66 degrees C.

Preparation of Oil Phase

A total of 378 parts of [low molecular weight polyester 1], 100 parts of paraffin wax having a Tg of 71 degrees C., 90 parts of [crystalline polyester 1], and 947 pars of ethyl acetate were placed in a container equipped with a stirrer and a thermometer. The system was heated to 80 degrees C. and maintained as it was for five hours and then cooled down to 30 degrees C. in one hour. Next, 500 parts of [master batch 1] and 500 parts of ethyl acetate were placed in the container followed by mixing for one hour to obtain a [raw material solution 1].

A total of 1,324 parts of [raw material solution 1] was transferred to the container to disperse carbon black and the wax using a bead mill (ULTRAVISCOMTLL from A1MEX) under the following conditions: Liquid feeding speed of 1 kg/hour; disc rotation perimeter speed of 6 m/sec; diameter of zirconia beads of 0.5 mm; filling factor of zirconia beads at 80 percent by volume; and repeat number of dispersion treatment of 3 passes. Next, 1,324 parts of ethyl acetate solution at 65 percent of [low molecular weight polyester 1] was added followed by two passes by the bead mill under the conditions mentioned above to obtain [pigment wax liquid dispersion 1] (oil phase). The concentration of the solid content of [pigment wax liquid dispersion 1] was 50 percent at 130 degrees C. for 30 minutes.

Emulsification and Removal of Solvent

A total of 749 parts of [pigment wax liquid dispersion 1], 115 parts of [prepolymer 1], and 2.9 parts of [ketimine compound 1] were placed in a container and mixed using a TK HOMOMIXER (manufactured by Tokushu Kika Kogyo Co., Ltd.) at 5,000 rpm for two minutes. Thereafter, 1,200 parts of [aqueous phase 1] was added in the container and the mixture was mixed by the TK HOMOMIXER at 13,000 rpm for 25 minutes to obtain [emulsified slurry 1].

[Emulsified slurry 1] was placed in a container equipped with a stirrer and a thermometer followed by removal of the solvent at degrees C. for 8 hours. Subsequent to a 48 hour aging at 45 degrees C., [slurry dispersion 1] was obtained.

Washing and Drying

After 100 parts of [slurry dispersion 1] was filtered with a reduced pressure:

(I): 100 parts of deionized water was added to the filtered cake and the mixture was mixed by a TK HOMOMIXER at a rate of rotation of 12,000 rpm for 10 minutes;
(2): 100 parts of sodium hydroxide at 10 percent was added to the filtered cake obtained in (1) and the resulting mixture was mixed by a TK HOMOMIXER (at 12,000 rpm for 30 minutes) followed by filtering with a reduced pressure;
(3): 100 parts of hydrochloric acid at 10 percent was added to the filtered cake obtained in (2) and the resulting mixture was mixed by a TK HOMOMIXER (at 12,000 rpm for 10 minutes) followed by filtering; and
(4): 300 parts of deionized water was added to the filtered cake obtained in (3) and the resulting mixture was mixed by a TK HOMOMIXER at a rate of rotation of 12,000 rpm for 10 minutes followed by filtering twice to obtain [filtered cake 1].

[Filtered cake 1] was dried by a circulation drier at 45 degrees C. for 48 hours. The dried matter was screened by a mesh having an opening of 75 μm to obtain [mother toner particle 1].

Thereafter, 100 parts of [mother toner particle 1] and 2 parts of hydrophobized silica having a particle diameter of 18 nm were mixed with a HENSCHEL MIXER to prepare toner.

The properties of the toner obtained are shown in Table 1 and the evaluation results are shown in Table 2. The evaluation apparatus A was used for the evaluation.

### Example 2

A toner was manufactured in the same manner as in Example 1 except that [particulate liquid dispersion 1] was changed to the following [particulate liquid dispersion 2].

The properties of the toner obtained are shown in Table 1 and the evaluation results are shown in Table 2. The evaluation apparatus A was used for the evaluation.

Synthesis of Resin Particulate Emulsion

The following recipe was placed in a reaction container equipped with a stirrer and a thermometer and stirred at 3,800 rpm for 20 minutes to obtain a white emulsion:

Water: 683 parts

Sodium salt of sulfuric acid ester of an adduct of methacrylic acid with ethylene oxide (EREMINOR RS-30, manufactured by Sanyo Chemical Industries, Ltd.): 11 parts

Polylactic acid; 5 parts

Styrene: 50 parts

Methacrylic acid: 110 parts

Butyl acrylate: 70 parts

Ammonium persulfate: 1 part.

The system was heated to 75 degrees C. to conduct reaction for 2.5 hours. Furthermore, 30 parts of 1 percent ammonium persulfate aqueous solution was added followed by aging at 65 degrees C. for nine hours to obtain an aqueous liquid dispersion of [particulate liquid dispersion 2] of a vinyl-based resin (copolymer of sodium salt of sulfuric acid of styrene-methacrylic acid-butyl acrylate-an adduct of methacrylic acid with ethylene oxide. [Particulate liquid dispersion 2] had a volume average particle diameter of 210 nm as measured with LA-920. The resin portion was isolated by drying a portion of [particulate liquid dispersion 2]. The resin portion had a glass transition temperature (Tg) of 60 degrees C. and a weight average molecular weight of 60,000.

### Example 3

A toner was manufactured in the same manner as in Example 1 except that [particulate liquid dispersion 1] was changed to the following [particulate liquid dispersion 3] and [low molecular weight polyester 1] was changed to [low molecular weight polyester 2].

The properties of the toner obtained are shown in Table 1 and the evaluation results are shown in Table 2. The evaluation apparatus A was used for the evaluation.

Synthesis of Resin Particulate Emulsion

The following recipe was placed in a reaction container equipped with a stirrer and a thermometer and stirred at 2,000 rpm for 20 minutes to obtain a white emulsion:

Water: 683 parts

Sodium salt of sulfuric acid ester of an adduct of methacrylic acid with ethylene oxide (EREMINOR RS-30, manufactured by Sanyo Chemical Industries, Ltd.): 11 parts

Polylactic acid; 5 parts

Styrene: 60 parts

Methacrylic acid: 100 parts

Butyl acrylate: 70 parts

Ammonium persulfate: 1 part.

The system was heated to 75 degrees C. to conduct reaction for 3 hours. Furthermore, 30 parts of ammonium persulfate aqueous solution at 1 percent was added followed by aging at 65 degrees C. for nine hours to obtain an aqueous liquid dispersion of [particulate liquid dispersion 3] of a vinyl-based resin (copolymer of sodium salt of sulfuric acid of styrene-methacrylic acid-butyl acrylate-an adduct of methacrylic acid with ethylene oxide. [Particulate liquid dispersion 3] had a volume average particle diameter of 110 nm as measured by LA-920. A resin portion was isolated by drying a portion of [particulate liquid dispersion 3]. The resin portion had a glass transition temperature (Tg) of 62 degrees C. and a weight average molecular weight of 80,000.

Synthesis of Polyester Having Small Molecular Weight

The following components were placed in a reaction container equipped with a condenser, a stirrer, and a nitrogen introducing tube to conduct reaction at 230 degrees C. at normal pressure for 8 hours followed by 4 hour reaction with a reduced pressure of 10 mmHg to 15 mmHg:

Adduct of bisphenol A with 2 mols of ethylene oxide: 229 parts

Adduct of bisphenol A with 3 mols of propylene oxide: 264 parts

Terephthalic acid: 208 parts

Trimellitic anhydride: 80 parts

Dibutyl tin oxide: 2 parts

Thereafter, 35 parts of trimellitic anhydride was put into the reaction container to conduct reaction at 180 degrees C. and normal pressure for 2 hours to obtain [low molecular weight polyester 2]. [Low Molecular weight polyester 2] had a number average molecular weight of 2,100, a weight average molecular weight of 4,500, a glass transition temperature of 39 degrees C., and an acid value of 25 mgKOH/g.

### Example 4

A toner was manufactured in the same manner as in Example 1 except that [particulate liquid dispersion 1] was changed to the following [particulate liquid dispersion 4].

The properties of the toner obtained are shown in Table 1 and the evaluation results are shown in Table 2. The evaluation apparatus A was used for the evaluation.

Synthesis of Resin Particulate Emulsion

The following recipe was placed in a reaction container equipped with a stirrer and a thermometer and stirred at 2,000 rpm for 20 minutes to obtain a white emulsion:

Water: 683 parts

Sodium salt of sulfuric acid ester of an adduct of methacrylic acid with ethylene oxide (EREMINOR RS-30, manufactured by Sanyo Chemical Industries, Ltd.): 11 parts

Polylactic acid: 7 parts

Styrene: 60 parts

Methacrylic acid: 100 parts

Butyl acrylate: 70 parts

Ammonium persulfate: 1 part.

The system was heated to 75 degrees C. to conduct reaction for 3 hours. Furthermore, 30 parts of an aqueous solution of ammonium persulfate at 1 percent was added followed by aging at 65 degrees C. for nine hours to obtain an aqueous liquid dispersion of [particulate liquid dispersion 4] of a vinyl-based resin (copolymer of sodium salt of sulfuric acid of styrene-methacrylic acid-butyl acrylate-an adduct of methacrylic acid with ethylene oxide. [Particulate liquid dispersion 4] had a volume average particle diameter of 120 nm as measured with LA-920. A resin portion was isolated by drying a portion of [particulate liquid dispersion 4]. The resin portion had a glass transition temperature (Tg) of 61 degrees C. and a weight average molecular weight of 70,000.

### Example 5

Synthesis of Non-Crystalline Polyester Resin 5

Terephthalic acid: 143 parts

Tetrapropenyl succinic anhydride: 187 parts

Adduct of bisphenol A with ethylene oxide: 216 parts

Ethylene glycol: 38 parts

Tetrabutoxy titanate (catalyst): 0.037 parts

The component mentioned above was placed in a heated and dried two-necked flask. Nitrogen gas was introduced into the flask to maintain the system in an inert gas atmosphere while stirring and raising the temperature to achieve cocondensation polymerization reaction at 160 degrees C. for eight hours. Thereafter, the temperature of the system was raised to 220 degrees C. while gradually reducing the pressure to 1.3 kPa and maintained for 3.5 hours. After the pressure was temporarily back to normal pressure, 9 parts of trimellitic anhydride was added and the pressure was gradually reduced to 1.3 kPa again. [Non-crystalline polyester resin 5] was synthesized after maintaining at 220 degrees C. for one hour. The resin had a weight average molecular weight of 42,000 and a glass transition temperature of 62 degrees C.

Preparation of Resin Particle Liquid Dispersion 5

[Non-crystalline polyester resin 5]: 160 parts

Ethyl acetate: 233 parts

Aqueous solution (0.3 N) of sodium hydroxide: 0.1 parts

The component mentioned above was placed in a separable flask and heated at 70 degrees C. followed by stirring with a three one motor (manufactured by SHINTO Scientific Co., Ltd.) at a rate of stirring speed of 80 rpm, to prepare a resin liquid mixture. Further stirring this resin liquid mixture, 373 parts of deionized water was gradually added to achieve transfer phase emulsification for removing the solvent. [Resin particle liquid dispersion 5] was thus obtained having an average particle diameter of 0.14 μm with a concentration of solid content of 30 percent.

Manufacturing of Crystalline Resin Particle Liquid Dispersion 5

A total of 150 parts of [crystalline polyester 1] was placed in 850 parts of distilled water followed by mixing and stirring with a homogenizer (Ultra Tarax, manufactured by IKA Japan) while heating to 80 degrees C. to obtain [crystalline resin particle liquid dispersion 5].

Preparation of Releasing Agent Liquid Dispersion

Paraffin wax (melting point of 70 degrees C., manufactured by Nippon Seiro Co., Ltd.): 50 parts

Anionic surfactant (NEOGEN RK, manufactured by DKS Co., Ltd.): 1.0 part

Deionized water: 200 parts

The component mentioned above was heated to 95 degrees C. and dispersed with a homogenizer (Ultra Tarax T50, manufactured by IKA Japan) followed by dispersion treatment with Manton-Gaulin high pressure homogenizer, manufactured by Gaulin) for 360 minutes to prepare [releasing agent liquid dispersion 5] (with a solid content concentration of 20 percent) in which releasing agent particles having a number average particle diameter of 0.22 μm were dispersed.

Preparation of Coloring Agent Liquid Dispersion

Cyan pigment (C.I.Pigment Blue 15:3, copper phthalocyanine, trade name: Fastogen Blue LA5380, manufactured by DIC Corporation): 200 parts

Anionic surfactant (NEOGEN R, manufactured by DKS Co., Ltd.): 1.5 parts

Deionized water: 800 parts

The component mentioned above was mixed for one hour with an emulsification dispersing machine (CAVITRON® CR1010, manufactured by Pacific Machinery & Engineering Co., Ltd.) to prepare [coloring agent liquid dispersion 5] (concentration of solid content of 20 percent) in which colored pigment particles (cyan pigment) were dispersed.

Manufacturing of Toner

Resin particle liquid dispersion 5: 450 parts

Crystalline resin liquid dispersion 5: 20 parts

Releasing agent liquid dispersion 5: 50 parts

Coloring agent liquid dispersion 5: 21 parts

Nonionic surfactant (IGEPAL CA 897): 1.40 parts

The material mentioned above was placed in a stainless container and dispersed for 10 minutes with a shearing force at 4,000 rpm with a homogenizer (Ultra Tarax T50, manufactured by IKA Japan). Next, the rate of rotation of the homogenizer was changed to 5,000 rpm for 15 minutes for dispersion while 2.86 parts of aqueous solution of nitric acid at 10 percent of polyaluminium chloride as an agglomeration agent was gradually dripped to the container to obtain a raw material liquid dispersion.

Thereafter, the raw material liquid dispersion was transferred to a container equipped with a stirrer having a two paddle stirring wings and a thermometer followed by heating with a mantle heater at a rate of stirring at 810 rpm to promote the growth of agglomeration particles at 56 degrees C. The pH of the raw material liquid dispersion was adjusted in the range of from 2.2 to 3.5 with nitric acid at 0.3N or an aqueous solution of sodium hydroxide at 1N. Agglomeration particles are formed after 1.5 hours in the range of the pH mentioned above.

The resulting reaction product was filtered and sufficiently rinsed with deionized water followed by drying with a vacuum drier to obtain [mother toner particle 5] having a cyan color.

Thereafter, 100 parts of [mother toner particle 5] and 2 parts of hydrophobized silica having a particle diameter of 18 nm were mixed with a HENSCHEL MIXER to prepare a toner.

The properties of the toner obtained are shown in Table 1 and the evaluation results are shown in Table 2. The evaluation apparatus A was used for the evaluation.

### Example 6

A toner was obtained in the same manner as in Example 1 except that [crystalline polyester 1] was excluded.

The properties of the toner obtained are shown in Table 1 and the evaluation results are shown in Table 2. The evaluation apparatus A was used for the evaluation.

### Example 7

The toner of Example 1 was used and evaluated by the evaluation apparatus B. These results are shown in Table 2.

### Example 8

A toner was manufactured in the same manner as in Example 1 except that [raw material solution 1] was changed to the following [raw material solution 2].

The properties of the toner obtained are shown in Table 1 and the evaluation results are shown in Table 2. The evaluation apparatus A was used for the evaluation.

Preparation of Oil Phase

A total of 378 parts of [low molecular weight polyester 1], 100 parts of paraffin wax having a Tg of 71 degrees C., 90 parts of [crystalline polyester 1], and 947 pars of ethyl acetate were placed in a container equipped with a stirrer and a thermometer. The system was heated to 80 degrees C. and maintained as it was for five hours and then cooled down to 30 degrees C. in one hour. Next, 500 parts of [master batch 1] and 500 parts of ethyl acetate were placed in the container followed by mixing for one hour to obtain a [raw material solution 2].

### Example 9

A toner was manufactured in the same manner as in Example 1 except that [raw material solution 1] was changed to the following [raw material solution 3].

The properties of the toner obtained are shown in Table 1 and the evaluation results are shown in Table 2. The evaluation apparatus A was used for the evaluation.

Preparation of Oil Phase

A total of 378 parts of [low molecular weight polyester 1], 100 parts of paraffin wax having a Tg of 71 degrees C., 90 parts of [crystalline polyester 1], and 947 pars of ethyl acetate were placed in a container equipped with a stirrer and a thermometer. The system was heated to 80 degrees C. and maintained as it was for five hours and then cooled down to 30 degrees C. in one hour. Next, 550 parts of [master batch 1] and 500 parts of ethyl acetate were placed in the container followed by mixing for one hour to obtain a [raw material solution 3].

### Example 10

A toner was manufactured in the same manner as in Example 1 except that [raw material solution 1] was changed to the following [raw material solution 4].

The properties of the toner obtained are shown in Table 1 and the evaluation results are shown in Table 2. The evaluation apparatus A was used for the evaluation.

Preparation of Oil Phase

A total of 378 parts of [low molecular weight polyester 1], 100 parts of paraffin wax having a Tg of 71 degrees C., 90 parts of [crystalline polyester 1], and 947 pars of ethyl acetate were placed in a container equipped with a stirrer and a thermometer. The system was heated to 80 degrees C. and maintained as it was for five hours and then cooled down to 30 degrees C. in one hour. Next, 630 parts of [master batch 1] and 500 parts of ethyl acetate were placed in the container followed by mixing for one hour to obtain a [raw material solution 4].

### Example 11

A toner was manufactured in the same manner as in Example 1 except that [particulate liquid dispersion 1] was changed to the following [particulate liquid dispersion 4] and [raw material solution 1] was changed to [raw material solution 3].

The properties of the toner obtained are shown in Table 1 and the evaluation results are shown in Table 2. The evaluation apparatus A was used for the evaluation.

### Example 12

A toner was manufactured in the same manner as in Example 1 except that [liquid slurry dispersion 1] was changed to the following [liquid slurry dispersion 2].

The properties of the toner obtained are shown in Table 1 and the evaluation results are shown in Table 2. The evaluation apparatus A was used for the evaluation.

Emulsification and Removal of Solvent

A total of 749 parts of [pigment wax liquid dispersion 1], 110 parts of [prepolymer 1], and 2.7 parts of [ketimine compound 1] were placed in a container and mixed using a TK HOMOMIXER (manufactured by Tokushu Kika Kogyo Co., Ltd.) at 5,000 rpm for two minutes. Thereafter, 1,200 parts of [aqueous phase 1] was added in the container and the mixture was mixed by the TK HOMOMIXER at 12,000 rpm for 10 minutes to obtain [emulsified slurry 2].

[Emulsified slurry 2] was placed in a container equipped with a stirrer and a thermometer followed by removal of the solvent at 30 degrees C. for 8 hours. Subsequent to a 24 hour aging at 45 degrees C., [slurry dispersion 2] was obtained.

### Example 13

A toner was manufactured in the same manner as in Example 1 except that [liquid slurry dispersion 1] was changed to the following [liquid slurry dispersion 3].

The properties of the toner obtained are shown in Table 1 and the evaluation results are shown in Table 2. The evaluation apparatus A was used for the evaluation.

Emulsification and Removal of Solvent

A total of 749 parts of [Pigment wax liquid dispersion 1], 110 parts of [prepolymer 1], and 2.7 parts of [ketimine compound 1] were placed in a container and mixed using a TK HOMOMIXER (manufactured by Tokushu Kika Kogyo Co., Ltd.) at 5,000 rpm for two minutes. Thereafter, 1,200 parts of [aqueous phase 1] was added in the container and the mixture was mixed by the TK HOMOMIXER at 12,000 rpm for 25 minutes to obtain [emulsified slurry 3].

[Emulsified slurry 3] was placed in a container equipped with a stirrer and a thermometer followed by removal of the solvent at 30 degrees C. for 8 hours. Subsequent to a 36 hour aging at 45 degrees C., [slurry dispersion 3] was obtained.

### Comparative Example 1

A toner was manufactured in the same manner as in Example 1 except that [particulate liquid dispersion 1] was changed to the following [particulate liquid dispersion 5].

The properties of the toner obtained are shown in Table 1 and the evaluation results are shown in Table 2. The evaluation apparatus A was used for the evaluation.

Synthesis of Resin Particulate Emulsion

The following recipe was placed in a reaction container equipped with a stirrer and a thermometer and stirred at 3,800 rpm for 30 minutes to obtain a white emulsion:

Water: 683 parts

Sodium salt of sulfuric acid ester of an adduct of methacrylic acid with ethylene oxide (EREMINOR RS-30, manufactured by Sanyo Chemical Industries, Ltd.): 11 parts

Polylactic acid; 2 parts

Styrene: 60 parts

Methacrylic acid: 100 parts

Butyl acrylate: 70 parts

Ammonium persulfate: 1 part

The system was heated to 75 degrees C. to conduct reaction for 4 hours. Furthermore, 30 parts of ammonium persulfate aqueous solution at 1 percent was added followed by aging at 75 degrees C. for eight hours to obtain an aqueous liquid dispersion of [particulate liquid dispersion 5] of a vinyl resin (copolymer of styrene-methacrylic acid-butyl acrylate-an adduct of sodium salt of sulfuric acid ester with methacrylic acid ethylene oxide. [Particulate liquid dispersion 5] had a volume average particle diameter of 420 nm as measured by LA-920. A resin portion was isolated by drying a portion of [particulate liquid dispersion 5]. The resin portion had a glass transition temperature (Tg) of 6 degrees C. and a weight average molecular weight of 140,000.

### Comparative Example 2

A toner was manufactured in the same manner as in Example 1 except that [particulate liquid dispersion 1] was changed to the following [particulate liquid dispersion 7].

The properties of the toner obtained are shown in Table 1 and the evaluation results are shown in Table 2. The evaluation apparatus A was used for the evaluation.

Synthesis of Resin Particulate Emulsion

The following recipe was placed in a reaction container equipped with a stirrer and a thermometer and stirred at 1,500 rpm for 20 minutes to obtain a white emulsion:

Water: 683 parts

Sodium salt of sulfuric acid ester of an adduct of methacrylic acid with ethylene oxide (EREMINOR RS-30, manufactured by Sanyo Chemical Industries, Ltd.): 11 parts

Polylactic acid: 2 parts

Styrene: 40 parts

Methacrylic acid: 100 parts

Butyl acrylate: 90 parts

Ammonium persulfate: 1 part.

The system was heated to 75 degrees C. to conduct reaction for 3 hours. Furthermore, 30 parts of ammonium persulfate aqueous solution at 1 percent was added followed by aging at 65 degrees C. for five hours to obtain an aqueous liquid dispersion of [particulate liquid dispersion 6] of a vinyl resin (copolymer of styrene-methacrylic acid-butyl acrylate-an adduct of sodium salt of sulfuric acid ester with methacrylic acid ethylene oxide. [Particulate liquid dispersion 6] had a volume average particle diameter of 70 nm as measured by LA-920. A resin portion was isolated by drying a portion of [particulate liquid dispersion 6]. The resin portion had a glass transition temperature (Tg) of 59 degrees C. and a weight average molecular weight of 120,000.

### Comparative Example 3

A toner was manufactured in the same manner as in Example 1 except that [particulate liquid dispersion 1] was changed to the following [particulate liquid dispersion 6] and [low molecular weight polyester 1] was changed to [low molecular weight polyester 3].

The properties of the toner obtained are shown in Table 1 and the evaluation results are shown in Table 2. The evaluation apparatus A was used for the evaluation.

Synthesis of Polyester Having Small Molecular Weight

The following components were placed in a reaction container equipped with a condenser, a stirrer, and a nitrogen introducing tube to conduct reaction at 230 degrees C. at normal pressure for 10 hours followed by 8 hour reaction with a reduced pressure of 10 to 15 mmHg:

Adduct of bisphenol A with 2 mols of ethylene oxide: 229 parts

Adduct of bisphenol A with 3 mols of propylene oxide: 529 parts

Terephthalic acid: 208 parts

Trimellitic anhydride: 46 parts

Dibutyl tin oxide: 2 parts

Thereafter, 70 parts of trimellitic anhydride was put into the reaction container to conduct reaction at 180 degrees C. and normal pressure for 3 hours to obtain [low molecular weight polyester 3]. [Low molecular weight polyester 3] had a number average molecular weight of 2,900, a weight average molecular weight of 7,300, a glass transition temperature of 48 degrees C., and an acid value of 25 mgKOH/g.

### Comparative Example 4

A toner was manufactured in the same manner as in Example 1 except that [low molecular weight polyester 1] was changed to the following [low molecular weight polyester 4].

The properties of the toner obtained are shown in Table 1 and the evaluation results are shown in Table 2. The evaluation apparatus A was used for the evaluation.

Synthesis of Polyester Having Small Molecular Weight

The following components were placed in a container equipped with a condenser, a stirrer and a nitrogen introducing tube to conduct reaction at 230 degrees C. under normal pressure for 14 hours followed by another reaction for 7 hours with a reduced pressure of 10 mmHg to 15 mmHg to synthesize [low molecular weight polyester 4]:

Adduct of bisphenol A with 2 mols of ethylene oxide: 682 parts

Adduct of bisphenol A with 2 mole of propylene oxide: 81 parts

Terephthalic acid: 283 parts

Trimellitic anhydride: 44 parts

Dibutyl tin oxide: 2 parts The obtained [low molecular weight polyester 4] had a number average molecular weight of 4,800, a weight average molecular weight of 32,000, a glass transition temperature of 64 degrees C., an acid value of 0.5 mgKOH/g, and a hydroxyl value of 52 mgKOH/g.

### Comparative Example 5

A toner was manufactured in the same manner as in Example 1 except that [particulate liquid dispersion 1] was changed to [particulate liquid dispersion 5] and [low molecular weight polyester 1] was changed to [low molecular weight polyester 3].

The properties of the toner obtained are shown in Table 1 and the evaluation results are shown in Table 2. The evaluation apparatus A was used for the evaluation.

### Comparative Example 6

A toner was manufactured in the same manner as in Example 1 except that [particulate liquid dispersion 1] was changed to [particulate liquid dispersion 5] and [low molecular weight polyester 1] was changed to [low molecular weight polyester 4].

The properties of the toner obtained are shown in Table 1 and the evaluation results are shown in Table 2. The evaluation apparatus A was used for the evaluation.

### Comparative Example 7

The toner of Example 1 was used and evaluated by the evaluation apparatus C. These results are shown in Table 2.

Evaluation Item

1. Gloss Stability

A chart with an image area of 3 percent was printed on 30,000 sheets using the obtained two-component developing agents and the evaluation apparatus. While changing the fixing temperature by 5 degrees, the image was output (incidence angle of 60 degrees) and the gloss thereof was measured. The gloss meter used was NIPPON DENSHOKU GlossMeter VG7000. The transfer sheet used was Ricoh Full color PPC type 6200. The attachment force of toner was set to be 0.85 mg/cm². The gloss difference between the highest and the lowest in the fixable temperature range free of coiling during fixing and toner peeling was evaluated according to the following evaluation criteria.

Gloss stability=(Gloss at highest fixing temperature at which gloss is highest)−(Gloss at lowest fixing temperature at which gloss is lowest)

Evaluation Criteria

A: Value of gloss stability is less than 8
B: Value of gloss stability is from 8 to less than 13
C: Value of gloss stability is from 13 to less than 25
D: Value of gloss stability is greater than 25

Low Temperature Fixability

A chart with an image area of 3 percent was printed on 30,000 sheets using the obtained two-component developing agents and the evaluation apparatus. While changing the fixing temperature by 5 degrees, the image was output and the low temperature fixability thereof was measured. The transfer sheet used was Ricoh Full color PPC type 6200.

A print image having an image density of 1.2 was obtained by changing the fixing temperature of the fixing device alone as measured with X-Rite 938. The copy images at each temperature were abraded with a Laufer eraser PLAST-0140 having a stronger peeling-off force against media such as paper than a typical eraser such as MONO eraser made by Tombow in Japan) 50 times using a clock meter equipped with the eraser. The image density before and after the erasure was measured to obtain the fixing ratio.

Fixing ratio;{(image density after abrasion with erasure 10 times)/(image density before)}×100

The temperature below which the fixing ratio was less than 80 percent was defined as the lowest fixing temperature. The low temperature fixability was evaluated according to the following evaluation criteria.

### Evaluation Criteria

S: The lowest fixing temperature was lower than 110 degrees C.
A: The lowest fixing temperature was from 110 to lower than 120 degrees C.
B: The lowest fixing temperature was from 120 to lower than 130 degrees C.
C: The lowest fixing temperature was 130 degrees C. or higher

3. High Temperature Stability

The toner was weighed for 10 g and placed in a glass vessel followed by tapping with a tapping device 300 times. The vessel was placed and allowed to rest for 48 hours in a thermostatic chamber set at a temperature of 55 degrees C. and a humidity of 80 percent RH. The toner was subjected to a penetration test with a penetration tester (manufactured by “Nikka Engineering Sha”, following the conditions described in the manual). Toner stored in a low temperature and low humidity (10 degrees C. and 15 percent RH) was subjected to the penetration test and evaluation. The toner having a smaller penetration value in a high temperature and high humidity environment and a low temperature and low humidity environment was adopted and evaluated. From better to worse:

S: 20 mm or greater
A: 15 to less than 20 mm
B: 10 to less than 15 mm
C: less than 10 mm

4. Development Stability

A chart having an image area ratio of 2 percent was subjected to an output durability test and continuously printed on 10,000 sheets using the obtained two-component developing agents and the evaluation apparatus. The toner was weight for 1 gram and the change in the charge capacity was obtained by a blow-off method. A chart having an image area ratio of 60 percent was subjected to an output durability test and evaluated on the change in the charge capacity. The toner was weight for 1 gram and the change in the charge capacity was obtained by a blow-off method. The value of change of the two larger than the other was adopted.

A: Change in capacity of 5 pc/g or less
B: Change in capacity of from 5 to 10 pc/g
C: Change in capacity surpassing 10 pc/g or less

Blow-Off Method

The developing agent was placed in a cylindrical Faraday cage having both ends wire netted. The toner was detached from the developing agent by a high pressure air and then the amount of charge remaining was measured with an electrometer. The toner mass of the developing agent was obtained by the mass difference of the Faraday cage before and after the blow-off.

TABLE 1

| | | Flow | | | |
|---|---|---|---|---|---|
| | Flow | index | Softening | | |
| | index Tf | Te | index Tw | | |
| | (degrees | (degrees | (degrees | Tinting | Shell |
| | C.) | C.) | C.) | strength | layer |
| Example 1 | 88 | 89 | 73 | 2.1 | Yes |
| Example 2 | 121 | 120 | 80 | 1.8 | Yes |
| Example 3 | 70 | 83 | 65 | 2.2 | Yes |
| Example 4 | 90 | 100 | 67 | 1.9 | Yes |
| Example 5 | 99 | 85 | 74 | 2.2 | None |
| Example 6 | 121 | 119 | 80 | 2.0 | Yes |
| Example 8 | 87 | 89 | 73 | 1.7 | Yes |
| Example 9 | 89 | 90 | 73 | 2.3 | Yes |
| Example 10 | 89 | 90 | 73 | 2.2 | Yes |
| Example 11 | 89 | 96 | 70 | 2.2 | Yes |
| Example 12 | 88 | 90 | 73 | 2.1 | Yes |
| Example 13 | 88 | 90 | 73 | 2.1 | Yes |
| Comparative | 121 | 122 | 79 | 1.7 | Yes |
| Example 1 | | | | | |
| Comparative | 72 | 75 | 67 | 1.8 | Yes |
| Example 2 | | | | | |
| Comparative | 68 | 78 | 66 | 2.3 | Yes |
| Example 3 | | | | | |
| Comparative | 123 | 119 | 80 | 2.2 | Yes |
| Example 4 | | | | | |
| Comparative | 73 | 79 | 63 | 1.9 | Yes |
| Example 5 | | | | | |
| Comparative | 120 | 118 | 82 | 1.9 | Yes |
| Example 6 | | | | | |

| | | | | Particle | | |
|---|---|---|---|---|---|---|
| | | | | diameter | | |
| | | | | Weight | Number | |
| | Aver- | | | average | average | |
| | age | Shape factor | | particle | particle | |
| | circu- | SF- | SF- | diameter | diameter | |
| | larity | 1 | 2 | (D₄) | (Dn) | D₄/Dn |
| Example 1 | 0.96 | 130 | 120 | 4.8 | 4.5 | 1.07 |
| Example 2 | 0.96 | 129 | 132 | 5.8 | 5.2 | 1.12 |
| Example 3 | 0.98 | 117 | 113 | 3.2 | 2.7 | 1.19 |
| Example 4 | 0.97 | 133 | 138 | 4.9 | 4.4 | 1.11 |
| Example 5 | 0.96 | 134 | 136 | 4.6 | 4.2 | 1.10 |
| Example 6 | 0.96 | 132 | 122 | 5.1 | 4.5 | 1.13 |
| Example 8 | 0.99 | 110 | 107 | 5.1 | 4.9 | 1.04 |
| Example 9 | 0.96 | 133 | 122 | 4.6 | 4.0 | 1.15 |
| Example 10 | 0.92 | 150 | 140 | 5.6 | 4.7 | 1.19 |
| Example 11 | 0.93 | 151 | 141 | 5.8 | 4.9 | 1.18 |
| Example 12 | 0.95 | 137 | 129 | 1.9 | 1.5 | 1.27 |
| Example 13 | 0.95 | 134 | 126 | 6.1 | 5.1 | 1.20 |
| Comparative | 0.98 | 117 | 122 | 4.9 | 4.1 | 1.20 |
| Example 1 | | | | | | |
| Comparative | 0.96 | 140 | 138 | 6.1 | 5.0 | 1.22 |
| Example 2 | | | | | | |
| Comparative | 0.92 | 138 | 157 | 5.3 | 4.3 | 1.23 |
| Example 3 | | | | | | |
| Comparative | 0.93 | 156 | 156 | 7.3 | 5.8 | 1.26 |
| Example 4 | | | | | | |
| Comparative | 0.95 | 149 | 138 | 5.1 | 4.5 | 1.13 |
| Example 5 | | | | | | |
| Comparative | 0.96 | 151 | 142 | 4.8 | 4.5 | 1.07 |
| Example 6 | | | | | | |

TABLE 2

| | | Low | High | Develop- |
|---|---|---|---|---|
| | Gloss | temperature | temperature | ment |
| | stability | fixability | storage | stability |
| Example 1 | A | A | A | A |
| Example 2 | S | B | S | A |
| Example 3 | B | S | B | B |
| Example 4 | A | S | A | A |
| Example 5 | B | A | S | A |
| Example 6 | B | B | A | A |
| Example 7 | S | B | A | A |
| Example 8 | B | A | A | A |
| Example 9 | B | A | A | B |
| Example 10 | B | A | A | B |
| Example 11 | B | A | A | B |
| Example 12 | B | A | B | B |
| Example 13 | B | A | A | A |
| Comparative | A | C | A | B |
| Example 1 | | | | |
| Comparative | C | A | C | C |
| Example 2 | | | | |
| Comparative | C | B | C | C |
| Example 3 | | | | |
| Comparative | B | C | B | A |
| Example 4 | | | | |
| Comparative | B | C | C | C |
| Example 5 | | | | |
| Comparative | A | C | B | B |
| Example 6 | | | | |
| Comparative | C | C | A | A |
| Example 7 | | | | |

The aspects of the present disclosure are, for example, as follows:

(1). An image forming apparatus includes a developing device accommodating toner, the toner containing a binder resin and a coloring agent and a fixing device configured to fix a toner image formed with the toner on a recording medium, the fixing member including a tubular belt member, a heating member configured to heat the tubular belt member directly or indirectly in contact with the tubular belt member, and a pressing member in contact with the tubular belt member, wherein the toner under a load of 2 kg has a flow index Tf of from 70 to 121 degrees C., a flow index Te of from 83 to 120 degrees C., and a softening index Tw of from 65 to 80 degrees C.

(2). The toner according to (1) mentioned above, wherein the binder resin contains a crystalline polyester resin.

(3). The toner according to (1) or (2) mentioned above, wherein the binder resin contains a non-crystalline polyester resin.

(4). The image forming apparatus according to any one of (1) to (3) mentioned above, wherein the toner has a core-shell structure.

(5). The image forming apparatus according to any one of (1) to (4) mentioned above, wherein the toner has a weight average particle diameter (D4) of from 2.0 to 6.0 μm and the ratio of D4 to the number average particle diameter (Dn) of the toner is from 1.00 to 1.20.

(6). The image forming apparatus according to any one of (1) to (5) mentioned above, wherein the toner has a tinting strength of from 1.8 to 2.2.

(7). The image forming apparatus according to any one of (1) to (6) mentioned above, wherein the toner has an average circularity of from 0.93 to 0.99.

(8). The image forming apparatus according to any one of (1) to (7) mentioned above, wherein the toner has a shape factor SF-1 of from 100 to 150, and a shape factor SF-2 of from 100 to 140.

(9). The image forming apparatus according to any one of (3) to (8) mentioned above, wherein the binder resin contains a crystalline polyester resin and the non-crystalline polyester resin contains a modified polyester resin.

(10). The image forming apparatus according to any one of (1) to (9) mentioned above, wherein the fixing device has a pressing surface pressure during fixing is from 0.5 to 5 N/cm².

(11). The image forming apparatus according to any one of (1) to (10) mentioned above, wherein the belt member includes a substrate layer, a surface layer, and an elastic layer disposed between the substrate layer and the surface layer.

(12). A system of a toner and a fixing device, the toner containing a binder resin and a coloring agent, the fixing device configured to fix a toner image formed with the toner on a recording medium, the fixing device including a tubular belt member, a heating member configured to heat the tubular belt member directly or indirectly in contact with the tubular belt member, and a pressing member in contact with the tubular belt member, wherein the toner under a load of 2 kg has a flow index Tf of from 70 to 121 degrees C., a flow index Te of from 83 to 120 degrees C., and a softening index Tw of from 65 to 80 degrees C.

(13). A two-component developing agent contains the toner of (1) mentioned above and a magnetic carrier.

(14). An image forming method comprising: fixing a toner on a recording medium with a fixing device, wherein the toner comprises a binder resin; and a coloring agent, wherein the fixing device comprises a tubular belt member; a heating member configured to heat the tubular belt member directly or indirectly in contact with the tubular belt member; and a pressing member in contact with the tubular belt member, wherein the toner under a load of 2 kg has a flow index Tf of from 70 to 121 degrees C., a flow index Te of from 83 to 120 degrees C., and a softening index Tw of from 65 to 80 degrees C.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. An image forming apparatus comprising:
a developing device accommodating toner, the toner comprising:
a binder resin; and
a coloring agent; and
a fixing device configured to fix a toner image formed with the toner on a recording medium, the fixing device comprising:
a tubular belt member;
a heating member configured to heat the tubular belt member directly or indirectly in contact with the tubular belt member; and
a pressing member in contact with the tubular belt member,
wherein the toner under a load of 2 kg has a flow index Tf of from 70 to 121 degrees C., a flow index Te of from 83 to 120 degrees C., and a softening index Tw of from 65 to 80 degrees C.

2. The image forming apparatus according to claim 1, wherein the binder resin comprises a crystalline polyester resin.

3. The image forming apparatus according to claim 1, wherein the binder resin comprises a non-crystalline polyester resin.

4. The image forming apparatus according to claim 1, wherein the toner has a core-shell structure.

5. The image forming apparatus according to claim 1, wherein the toner has a weight average particle diameter (D4) of from 2.0 to 6.0 μm and a ratio of D4 to a number average particle diameter (Dn) of the toner is from 1.00 to 1.20.

6. The image forming apparatus according to claim 1, wherein the toner has a tinting strength of from 1.8 to 2.2.

7. The image forming apparatus according to claim 1, wherein the toner has an average circularity of from 0.93 to 0.99.

8. The image forming apparatus according to claim 1, wherein the toner has a shape factor SF-1 of from 100 to 150, and a shape factor SF-2 of from 100 to 140.

9. The image forming apparatus according to claim 3, wherein the binder resin comprises a crystalline polyester resin and the non-crystalline polyester resin comprises a modified polyester resin.

10. The image forming apparatus according to claim 1, wherein the fixing device has a pressing surface pressure during fixing is from 0.5 to 5 N/cm².

11. The image forming apparatus according to claim 1, wherein the belt member comprises a substrate layer, a surface layer, and an elastic layer disposed between the substrate layer and the surface layer.

12. A two-component developing agent comprising:
a toner comprising:
a binder resin; and
a coloring agent; and
a magnetic carrier,
wherein the toner under a load of 2 kg has a flow index Tf of from 70 to 121 degrees C., a flow index Te of from 83 to 120 degrees C., and a softening index Tw of from 65 to 80 degrees C.

13. An image forming method comprising:
fixing a toner on a recording medium with a fixing device,
wherein the toner comprises a binder resin; and
a coloring agent,
wherein the fixing device comprises a tubular belt member;
a heating member configured to heat the tubular belt member directly or indirectly in contact with the tubular belt member; and
a pressing member in contact with the tubular belt member,
wherein the toner under a load of 2 kg has a flow index Tf of from 70 to 121 degrees C., a flow index Te of from 83 to 120 degrees C., and a softening index Tw of from 65 to 80 degrees C.
